(19) United States
(12) Patent Application Publication
(10) Pub. No.: US 2019/0129831 A1
(43) Pub. Date: May 2, 2019

(54) Autonomous Vehicle Simulation Testing Systems and Methods

(71) Applicant: Uber Technologies, Inc., San Francisco, CA (US)

(72) Inventor: Joshua David Goldberg, San Francisco, CA (US)

(21) Appl. No.: 15/837,341

(22) Filed: Dec. 11, 2017

Related U.S. Application Data
(60) Provisional application No. 62/577,979, filed on Oct. 27, 2017.

(51) Int. Cl. G06F 11/36; G06F 3/0484

(52) U.S. Cl. CPC G06F 11/3664; B60W 50/04; G06F 3/04847; G06F 3/04845

(57) ABSTRACT

Systems and methods for autonomous vehicle testing are provided. In one example embodiment, a computer-implemented method includes presenting, by a computing system, a visual representation of a simulated environment via a user interface on a display device. The simulated environment includes a simulated object and a simulated autonomous vehicle. The method includes initiating, by the computing system, a simulation run associated with the simulated environment. The method includes, during the simulation run, obtaining, by the computing system, data indicative of a user input associated with a motion of the simulated object within the simulated environment. The method includes, in response to the user input and during the simulation run, controlling, by the computing system, the motion of the simulated object within the simulated environment based at least in part on the data indicative of the user input. The method also includes controlling the simulated autonomous vehicle within the simulated environment.

### PRIORITY CLAIM

The present application is based on and claims priority to U.S. Provisional Application 62/577,979 having a filing date of Oct. 27, 2017, which is incorporated by reference herein.

### FIELD

The present disclosure relates generally to testing the computing systems of an autonomous vehicle.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computing system for autonomous vehicle testing. The computing system including one or more processors and one or more tangible, non-transitory, computer readable media that collectively store instructions that when executed by the one or more processors cause the computing system to perform operations. The operations include presenting a visual representation of a simulated environment via a user interface on a display device. The simulated environment includes a simulated object and a simulated autonomous vehicle. The operations include initiating a simulation run associated with the simulated environment. The operations include, during the simulation run, obtaining data indicative of a user input associated with a motion of the simulated object within the simulated environment. The operations include, in response to the user input and during the simulation run, controlling the motion of the simulated object within the simulated environment based at least in part on the data indicative of the user input. The operations include obtaining data indicative of a motion trajectory of the simulated object within the simulated environment. The operations include storing the data indicative of the motion trajectory of the simulated object within the simulated environment in an accessible memory. The operations include obtaining, via an interface, an output from an autonomous vehicle computing system. The output includes data associated with a motion of the simulated autonomous vehicle. The motion of the simulated autonomous vehicle is based at least in part on the motion of the simulated object. The operations include controlling the motion of the simulated autonomous vehicle within the simulated environment based at least in part on the output from the autonomous vehicle computing system that is obtained via the interface.

Another example aspect of the present disclosure is directed to a computer-implemented method for testing autonomous vehicles. The method includes presenting, by a computing system that includes one or more computing devices, a visual representation of a simulated environment via a user interface on a display device. The simulated environment includes a simulated object and a simulated autonomous vehicle. The method includes initiating, by the computing system, a simulation run associated with the simulated environment. The method includes, during the simulation run, obtaining, by the computing system, data indicative of a user input associated with a motion of the simulated object within the simulated environment. The method includes, in response to the user input and during the simulation run, controlling, by the computing system, the motion of the simulated object within the simulated environment based at least in part on the data indicative of the user input. The method includes obtaining, by the computing system via an interface, an output from an autonomous vehicle computing system. The output is indicative of one or more command signals associated with a motion of the simulated autonomous vehicle. The motion of the simulated autonomous vehicle is based at least in part on the motion of the simulated object. The method includes controlling, by the computing system, the motion of the simulated autonomous vehicle within the simulated environment based at least in part on the output from the autonomous vehicle computing system that is obtained via the interface.

Yet another example aspect of the present disclosure is directed to an autonomous vehicle testing system. The system includes a user input device configured to provide data indicative of a user input associated with a motion of a simulated object. The system includes an autonomous vehicle computing system configured to control a simulated autonomous vehicle. The system includes a simulation computing system including one or more processors and one or more tangible, non-transitory, computer readable media that collectively store instructions that when executed by the one or more processors cause the simulation computing system to perform operations. The operations include presenting a visual representation of a simulated environment via a user interface on a display device. The simulated environment includes the simulated object and the simulated autonomous vehicle. The operations include initiating a simulation run associated with the simulated environment. The operations include, during the simulation run, obtaining, via the user input device, the data indicative of the user input associated with the motion of the simulated object within the simulated environment. The operations include, in response to the user input and during the simulation run, controlling the motion of the simulated object within the simulated environment based at least in part on the data indicative of the user input. The operations include obtaining, via an interface, an output from the autonomous vehicle computing system. The output is associated with a motion of the simulated autonomous vehicle. The operations include controlling the motion of the simulated autonomous vehicle within the simulated environment based at least in part on the output from the autonomous vehicle computing system.

Other example aspects of the present disclosure are directed to systems, methods, vehicles, apparatuses, tangible, non-transitory computer-readable media, and memory devices for autonomous vehicle simulation testing.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example testing system according to example embodiments of the present disclosure;

FIG. 2 depicts an example autonomous vehicle computing system according to example embodiments of the present disclosure;

FIG. 3 depicts an example user interface presenting an example simulated environment according to example embodiments of the present disclosure;

FIG. 4 depicts an example user interface presenting another example simulated environment according to example embodiments of the present disclosure;

FIG. 5 depicts an example user interface presenting another example simulated environment according to example embodiments of the present disclosure;

FIGS. 6A-B depict flow diagrams of example methods for testing autonomous vehicles according to example embodiments of the present disclosure; and

FIG. 7 depicts example system components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved testing of a (partially or fully) autonomous vehicle computing system based on user controlled simulated objects. For instance, an autonomous vehicle can be a vehicle that can drive, navigate, operate, etc. with little to no human input. To do so, the autonomous vehicle can include an autonomous vehicle computing system containing an autonomy software stack. The autonomy software stack can enable the autonomous vehicle to perceive object(s) within its surrounding environment, predict the motion of those objects, and plan the motion of the autonomous vehicle, accordingly. To help improve system functionality and software capabilities, the autonomous vehicle computing system can be tested in an offline, simulated environment.

The systems and methods of the present disclosure provide improved systems and methods for testing the autonomous vehicle computing system (e.g., the autonomy software stack) in a simulated testing environment. For example, a testing system can present a visual representation of a simulated environment via a user interface (e.g., graphical user interface) on a display device for a user (e.g., a test operator). The simulated environment can include at least one simulated object and a simulated autonomous vehicle, each depicted in the user interface for the user. The user can manipulate a user input device (e.g., steering wheel, bicycle handlebar, etc.) to control the motion of the simulated object within the simulated environment while the simulation is running (e.g., in real-time). In this way, the user can create simulation scenarios defining activity by a number of actor objects (e.g., automobiles, cycles, pedestrians, etc.) in the simulated environment to test the autonomous vehicle. By way of example, the simulated environment can include a multiple lane highway scenario in which the simulated autonomous vehicle is travelling in the right most traffic lane. During the simulation, the user can control a simulated object such as, a simulated vehicle, to cut-off (e.g., abruptly move in front of) the simulated autonomous vehicle. The testing system can obtain feedback data from the autonomous vehicle computing system indicating the simulated autonomous vehicle's response to the simulated scenario, including the user controlled motion/actions of the simulated object. This can allow the testing system to determine the ability of the autonomy software stack to address this type of cut-off maneuver. Moreover, as the simulated object moves within the simulated environment, the testing system can record the motion trajectory of the simulated object that is created by the user input. The testing system can store the motion trajectory in an accessible database such that the simulated object and its simulated movement can be accessed and reproduced in another simulated environment (e.g., during a later testing session, etc.). In this way, the testing systems and methods of the present disclosure provide a more realistic and repeatable testing scenario, while ultimately improving the autonomous vehicle computing system's response to objects proximate to the autonomous vehicle. As an example, in some instances, enabling user control of a simulated object within a simulated environment can enable the production of and testing of autonomous vehicle performance within scenarios that infrequently occur during real-world autonomous vehicle testing, including, for example, driving scenarios that include dangerous driving behavior or driving events or other undesirable scenarios.

More particularly, an autonomous vehicle testing system can be configured to test the abilities of an autonomous vehicle in an offline, simulated environment. The autonomous vehicle testing system can include, for example, a user input device, an autonomous vehicle computing system, and a simulation system. The user input device and the autonomous vehicle computing system can be communicatively coupled with the simulation system (e.g., via one or more wired and/or wireless networks). As further described herein, the simulation system can generate a simulated environment that includes at least one simulated object and a simulated autonomous vehicle.

The user input device can be configured to control the motion of the simulated object within the simulated environment. The simulated object can be a simulated actor such as, for example, a simulated vehicle, a simulated bicycle, a simulated motorcycle, a simulated pedestrian, and/or another type of object. The user input device can include, for example, a steering wheel, handle bar, joystick, gyroscope, touch screen, touch pad, mouse, data entry keys or buttons, a microphone suitable for voice recognition, camera, etc. In some implementations, the type of the user input device can have a form factor related to the type of the simulated object it is intended to control. By way of example, the user input device can include a steering wheel for controlling the motion of a simulated vehicle within the simulated environment. In another example, the user input device can include a handle bar for controlling the motion of a simulated bicycle or motorcycle within the simulated environment.

A user (e.g., a test operator) can provide user input to the user input device to control the motion of the simulated object during the simulation run in real-time and/or at least near real-time (e.g., accounting for any processing delays between when the user input device is manipulated and when the simulated object is moved within the simulated environment and/or when the movement is depicted via a user interface). The user can also provide user input to control other aspects of the simulated object. By way of example, the user can provide user input to activate a simulated horn, lights (e.g., hazard lights, turn signal, etc.), and/or other components of a simulated vehicle. The user input device can provide data indicative of a user input associated with a motion (and/or other aspects) of a simulated object to the simulation system.

The autonomous vehicle computing system can be configured to control the simulated autonomous vehicle within the simulated environment. The autonomous vehicle computing system can include an autonomy software stack that is the same as or at least similar to the software stack utilized on an autonomous vehicle (e.g., outside of a testing environment). In some implementations, the autonomy software stack utilized in the testing environment can also, or alternatively, include software (e.g., an updated version) that has not been deployed onto an autonomous vehicle. The autonomous vehicle computing system utilized in the testing system can include the components of an autonomy system that would be included in an autonomous vehicle that is acting outside of a testing scenario (e.g., deployed in the real-world for a vehicle service). For example, the autonomous vehicle computing system can include various sub-systems that cooperate to perceive the simulated environment of the simulated autonomous vehicle and determine a motion plan for controlling the motion of the simulated autonomous vehicle. The autonomous vehicle computing system can include a perception system that is configured to perceive the simulated environment of the simulated autonomous vehicle and the simulated object(s) within the simulated environment (e.g., based on simulated sensor data provided by the simulation system). The autonomous vehicle computing system can include a prediction system that is configured to predict the motion of the simulated object(s) within the simulated environment.

The autonomous vehicle computing system can also include a motion planning system that is configured to plan the motion of the simulated autonomous vehicle based at least in part on the perceived simulated environment, the simulated object(s), the predicted motion of the simulated object(s), etc. The autonomous vehicle computing system can provide data associated with the motion of the simulated autonomous vehicle within the simulated environment (and/or other data) to the simulation system. For example, the motion planning system can output a motion plan that describes an intended motion or trajectory of the simulated autonomous vehicle. While in real-world operation, the autonomous vehicle can typically include various components (e.g., one or more vehicle controllers) that control the autonomous vehicle to execute the motion plan. In some implementations, while in the simulated testing environment, the motion planning system can provide the motion plan to the simulation system and the simulation system can use the provided motion plan to simulate the motion of the autonomous vehicle within the simulated environment. In some implementations, the autonomous vehicle computing system (e.g., used in the offline testing) can include a vehicle controller system that simulates the functions of the vehicle controller(s). In such a case, the autonomous vehicle computing system can provide, to the simulation system, data indicative of instructions determined by the vehicle controller system based at least in part on the motion plan. The simulation system can control the simulated autonomous vehicle based at least in part on the data indicative of the vehicle controller system instructions.

The simulation system can be configured to generate a simulated environment and run a test simulation within that simulated environment. For instance, the simulation system can obtain data indicative of one or more initial inputs associated with the simulated environment. For example, a user can specify (e.g., via the same and/or one or more different user input devices) various characteristics of the simulated environment that include, for example: a general type of geographic area for the simulated environment (e.g., highway, urban, rural, etc.); a specific geographic area for the simulated environment (e.g., beltway of City A, downtown of City B, country side of County C, etc.); one or more geographic features (e.g., trees, benches, obstructions, buildings, boundaries, exit ramps, etc.) and their corresponding positions in the simulated environment; a time of day; one or more weather conditions; one or more initial conditions of the simulated object(s) within the simulated environment (e.g., initial position, heading, speed, etc.); a type of each simulated object (e.g., vehicle, bicycle, pedestrian, etc.); a geometry of each simulated object (e.g., shape, size etc.); one or more initial conditions of the simulated autonomous vehicle within the simulated environment (e.g., initial position, heading, speed, etc.); a type of the simulated autonomous vehicle (e.g., sedan, sport utility, etc.); a geometry of the simulated autonomous vehicle (e.g., shape, size etc.); operating condition of each simulated object (e.g., correct turn signal usage vs. no turn signal usage, functional brake lights vs. one or more brake lights that are non-functional, etc.) and/or other data associated with the simulated environment. The simulation system can obtain the data indicative of these initial input(s) and generate the simulated environment accordingly. In some implementations, one or more templates can be available for selection, which provide a standardized or otherwise pre-configured simulated environment and the user can select one of the templates and optionally modify the template environment with additional user input.

The simulation system can present a visual representation of the simulated environment via a user interface (e.g., graphical user interface) on a display device (e.g., display screen). The simulated environment can include the simulated object and the simulated autonomous vehicle (e.g., as visual representations on the user interface). For example, the simulated environment can be a highway environment in which the simulated autonomous vehicle is travelling in a traffic lane adjacent to a simulated object (e.g., a simulated vehicle). In another example, the simulated environment can be an urban intersection environment in which the simulated autonomous vehicle is travelling along a travel way that approaches a crosswalk and a simulated object (e.g., a simulated pedestrian) can be positioned near the crosswalk. The simulation system and display device can operate to provide various different views of the simulated environment including, as examples, a bird's eye or overhead view of the simulated environment, a view rendered from the vantage point of the object (e.g., from the driver's seat of the simulated object), a view rendered from the vantage point of the autonomous vehicle, and/or other views of the simulated environment.

The simulation system (e.g., via a user input device interface) can obtain data indicative of a user input associated with a motion of the simulated object within the simulated environment. For instance, the simulation system can initiate a simulation associated with the simulated environment. Such initiation can cause, for example, any simulated objects and/or the simulated autonomous vehicle to act in accordance with the initial conditions. Additionally, initiation of the simulation run can initiate any weather condition(s) and/or other conditions of the simulation. While the simulation is running, the user input can be provided, via the user input device, by the user (e.g., test operator) that is viewing the simulated environment on the user interface. In response, the simulation system can control the motion of the simulated object within the simulated environment based at least in part on the user input. For instance, during the simulation run, the simulation system can move the simulated object within the simulated environment in accordance with the user input and display such movement on the user interface (e.g., in real-time, at least near real-time, etc.). This can allow the user to view the movement of the simulated object as controlled by the user. By way of example, the user can manipulate a user input device (e.g., steering wheel) to control a simulated vehicle to cut-off the simulated autonomous vehicle in a simulated highway environment (e.g., to reach an exit ramp). As the user manipulates the user input device, the visual representation of the simulated object on the user interface can move within the simulated highway. In another example, the user can manipulate a user input device (e.g., handle bar) to control a simulated motorcycle to split a traffic lane boundary adjacent to the simulated autonomous vehicle. The simulation system can cause a visual representation of the simulated motorcycle to move accordingly within the simulated highway environment presented via the user interface. In another example, the user input can control a simulated pedestrian to travel within a simulated urban environment (e.g., to cross a crosswalk).

The simulation system can obtain state data indicative of one or more states of the simulated object within the simulated environment. For instance, as the simulated object moves within the simulated environment during a simulation run, the simulation system (e.g., a scenario recorder) can obtain state data indicative of one or more states of the simulated object at one or more times. The state(s) can be indicative of the position(s), heading(s), speed(s), etc. of the simulated object within the simulated environment at these one or more times. The simulation system can trace and/or track these state(s) to determine a motion trajectory of the simulated object that corresponds to the motion of the simulated object within the simulated environment.

The state(s) of the simulated object can be parameterized with respect to the simulated environment such that they are flexible across a variant of simulations. For instance, the state(s) can be parameterized into parameter data (e.g., indicative one or more parameters) within the context of the simulated environment (e.g., with respect to the simulated autonomous vehicle). This can allow the motion trajectory of the simulated object to be easily reproduced in a subsequent simulation. The parameter data can be indicative of a relationship (e.g., spatial relationship, temporal relationship, etc.) between the simulated object and the simulated environment (e.g., and/or the simulated autonomous vehicle). The parameter(s) can include metadata such as, for example, the relative distance between the simulated object and the simulated autonomous vehicle, the relative distance between the simulated object and another feature of the simulated environment (e.g., lane boundary, stop sign, exit ramp, cross walk, etc.), temporal parameters (e.g., the time it would take for the simulated autonomous vehicle to reach the simulated object, etc.), the velocity of the simulated autonomous vehicle when the simulated object reaches a certain state, and/or other parameters. By way of example, the simulation system can parameterize a simulated object on the simulated highway based on the distance between the simulated object and the simulated autonomous vehicle, the headway of the simulated autonomous vehicle, the speed of the simulated autonomous vehicle, etc. as the simulated object cuts-off the simulated autonomous vehicle. In another example, the simulation system can parameterize the state(s) of a simulated pedestrian crossing a crosswalk based on the distance between the simulated autonomous vehicle and the crosswalk and/or other parameter(s). In some implementations, the simulation system can obtain data indicative of one or more labels identifying which parameters (e.g., metadata) should be recorded by the simulation system. The user can provide user input indicative of the label(s) to the simulation system (e.g., via a user input device) before, during, and/or after a simulation. Thus, the user can control which parameter(s) are generated and/or recorded for each simulated object both before and after the simulation is conducted. For example, in some implementations, an additional user input can be used to control a timing at which each label should be marked during the simulation.

The simulation system can store the state data (e.g., in raw or parameterized form) and/or the motion trajectory associated with a simulated object in an accessible memory. The memory (e.g., a scenario memory) can include one or more memory devices that are local to and/or remote from the simulation system. The memory can be a library database that includes state data and/or motion trajectories of a plurality of simulated objects (e.g., generated based on user input) from a plurality of previously run simulations.

The state data and/or the motion trajectories of the simulated objects can be accessed, viewed, and/or selected for use in a subsequent simulation. For instance, the simulation system can generate a second simulation environment for a second simulation. The second simulation environment can be similar to and/or different from a previous simulation environment (e.g., a similar or different simulated highway environment). The simulation system can present the second simulated environment via a user interface on a display device. The simulation system can obtain (e.g., from the accessible memory) the state data indicative of the state(s) (e.g., in raw or parameterized form) of a simulated object and/or a motion trajectory of the simulated object within the first simulated environment. The simulation system can control a motion of the simulated object within the second simulated environment based at least in part on the state(s) and/or the motion trajectory of the simulated object within the first simulated environment. By way of example, the cut-off maneuver of the simulated vehicle within the first simulated environment can be reproduced within the second simulated environment such that the simulated vehicle follows the same motion trajectory as in the first simulated environment. In some implementations, at least one of the aforementioned parameters can be utilized to initiate (at least a portion of) the motion of the simulated object within the second simulated environment. For example, the cut-off maneuver of the simulated vehicle can be initiated when the simulated autonomous vehicle is at a certain distance from the simulated object, at a certain relative speed, etc. within the second simulated environment. In this way, the motion trajectory of the simulated object from one simulation can be leveraged for a subsequent simulation.

The simulation system can obtain feedback data associated with the autonomous vehicle computing system. For example, the simulation system can obtain the data generated by the autonomous vehicle computing system as it attempts to perceive and predict the motion of a simulated object and navigate the simulated autonomous vehicle within the simulated environment. For instance, the simulation system can obtain perception data associated with the simulated object, prediction data associated with the simulated object, and/or motion planning data associated with the simulated autonomous vehicle. The feedback data can include a motion plan or trajectory of the simulated autonomous vehicle as it navigates through the simulated environment.

The simulation system can evaluate the feedback data to determine the performance of the autonomous vehicle computing system during a simulation. For instance, the simulation system can compare the state data of the simulated object to the perception data to determine whether the autonomous vehicle computing system accurately perceived the state(s) of the simulated object. Additionally, or alternatively, the simulation system can compare the motion trajectory of the simulated object to the prediction data to determine whether the autonomous vehicle computing system has accurately predicted the motion of the simulated object. The simulation system can also, or alternatively, compare the motion planning data and/or the motion trajectory of the simulated autonomous vehicle to the motion trajectory of the simulated object to determine whether the autonomous vehicle computing system appropriately planned and controlled the motion of the simulated vehicle (e.g., to avoid collision with the simulated object). As another example, the acceleration and/or jerk associated with the simulated autonomous vehicle behavior can be measured, for example, to assess a degree of comfortability that would be experienced by a passenger of the simulated autonomous vehicle.

In some implementations, a plurality of user controlled simulated objects can be included in a simulated environment. In some implementations, a user (e.g., a test operator) can build the simulation scenario using an iterative, layered approach. For example, the user can provide a first user input to control a first simulated object (e.g., a simulated vehicle) during a first simulation run (e.g., at a first time period). Moreover, during the first simulation run, the simulation system can obtain state data associated with the first simulated object and store data indicative of a first motion trajectory of the first simulated object in an accessible memory, as described herein. The user can provide a second user input to control a second simulated object (e.g., a simulated motorcycle) during a second simulation run of the same simulated environment (e.g., at a second, subsequent time period). The simulation system can obtain state data associated with the second simulated object and store data indicative of a second motion trajectory of the second simulated object in the accessible memory. Moreover, as the user is providing the second user input to control the second simulated object, the first simulated object can move within the simulated environment according to the first motion trajectory. In this way, the simulation system can iteratively create the motion trajectories of the simulated objects within a simulation. In some implementations, more than one user can utilize the test system. For example, a first user (e.g., a first test operator) can control the motion of the first simulated object and a second user (e.g., a second test operator) can control the motion of the second simulated object (e.g., using a second user input device).

The systems and methods described herein provide a number of technical effects and benefits. For instance, the present disclosure provides systems and methods for improved testing of autonomous vehicles. In particular, by allowing a user to control a simulated object in at least near real-time while a simulation is running, the autonomous vehicle computing system (and its associated software stack) can be tested according to more realistic testing scenarios. For example, by allowing a user to control a simulated object via a user input device (e.g., a steering wheel), the simulated object will more likely move in a manner like that of a similar object in the real world.

The user controlled simulated objects can increase testing efficiency via improved simulation flexibility and reproducibility. For instance, the parameterization of the state(s) of the simulated object within the simulated environment can increase the ability to utilize the simulated object across multiple scenarios. Once a simulated object motion trajectory is created, it can be used over and over again to create a more consistent simulated object for testing. This can allow for reproducible inputs for better testing conditions. Additionally, the systems and methods of the present disclosure allow new and/or updated autonomous vehicle software to be tested based on previous scenarios faced by the simulated autonomous vehicle. This can allow a user to determine whether the new/updated software is outperforming a previous version with respect to a particular scenario, which can lead to easier performance analysis.

The systems and methods also improve the ability to implement complex testing conditions for an autonomous vehicle. For example, many objects interacting in a real world testing environment (e.g., test track) can be complicated and often dangerous to produce. The systems and methods of the present disclosure allow for the generation of very complex and realistic scenarios that can be more easily tested in a simulated environment.

The systems and methods of the present disclosure also provide an improvement to vehicle computing technology, such as autonomous vehicle testing computing technology. In particular, a computing system (e.g., simulation computing system) can present a visual representation of a simulated environment via a user interface on a display device. The simulated environment can include a simulated object and a simulated autonomous vehicle. The computing system can initiate a simulation run associated with the simulation environment. During the simulation run, the computing system can obtain data indicative of a user input associated with a motion of the simulated object within the simulated environment. In response to the user input and during the simulation run, the computing system can control (e.g., in at least near real time) the motion of the simulated object within the simulated environment based at least in part on the data indicative of the user input. The computing system can obtain state data indicative of one or more states of the simulated object (e.g., parameterized with respect to the simulated environment). The computing system can determine a motion trajectory of the simulated object based at least in part on the state(s). The computing system can store the state data and/or the motion trajectory in an accessible memory. As described herein, controlling simulated objects based on user input can lead to more realistic testing scenarios. Additionally, the collection and storage of the state data/motion trajectories allows for easy re-use of such simulated object/motion trajectories in subsequent simulations. This leads to a significant savings in processing resources that would otherwise be required to re-create these scenarios. Moreover, by parameterizing the simulated object's movement with respect to the context of a scenario, the movement of the simulated object can be used across multiple versions of the autonomy software stack. This can help avoid the redesign of software testing for updated versions of the autonomy software stack. Ultimately, the improved testing of the autonomous vehicle computing system can improve the ability of an autonomous vehicle to perceive its surrounding environment, predict object movement, plan vehicle motion, and safely navigate through the surrounding environment.

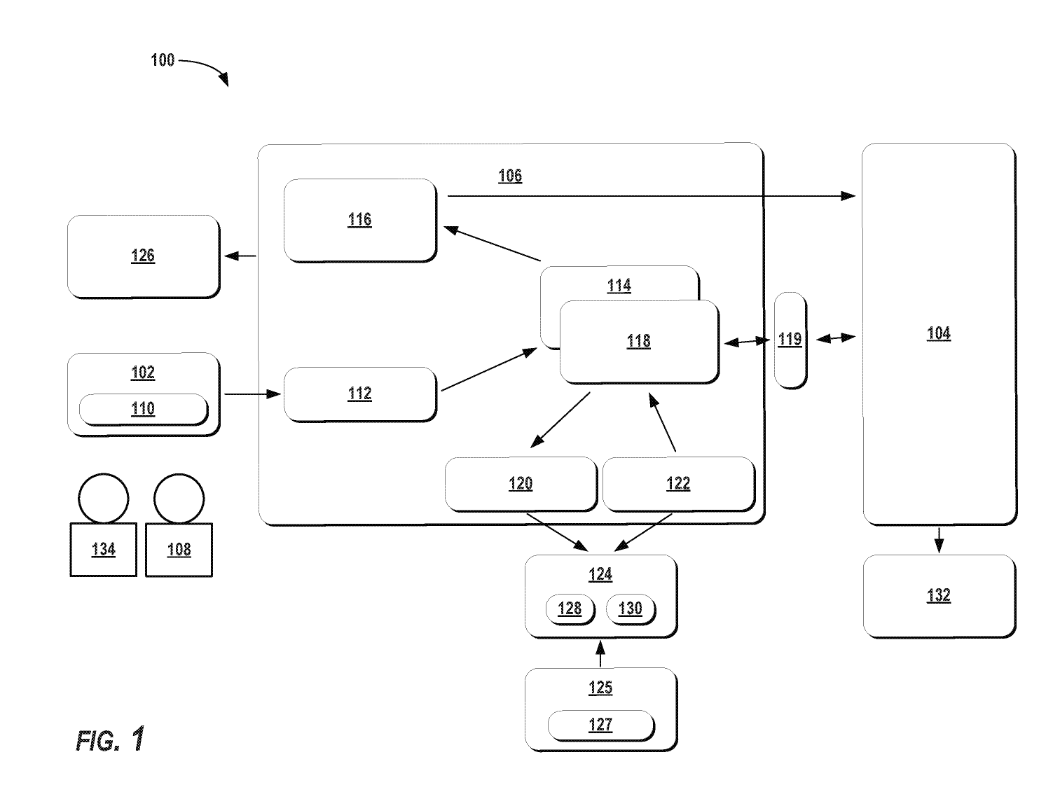

With reference now to the FIGS., example embodiments of the present disclosure will be discussed in further detail. FIG. 1 depicts an example autonomous vehicle testing system 100 according to example embodiments of the present disclosure. The testing system 100 can include, for example, a user input device 102, an autonomous vehicle computing system 104, and a simulation system 106. The testing system 100 can be configured to test the abilities of an autonomous vehicle computing system 104 (e.g., in offline testing). The user input device 102 and the autonomous vehicle computing system 104 can be communicatively coupled with the simulation system 106 (e.g., via one or more wired and/or wireless networks). As further described herein, the simulation system 106 can generate a simulated environment that includes at least one simulated object and a simulated autonomous vehicle.

The user input device 102 can be configured to control the motion of the simulated object within the simulated environment. The simulated object can be a simulated actor such as, for example, a simulated vehicle, a simulated bicycle, a simulated motorcycle, a simulated pedestrian, and/or another type of object. The user input device 102 can include, for example, a steering wheel, handle bar, joystick, gyroscope, touch screen, touch pad, mouse, data entry keys or buttons, a microphone suitable for voice recognition, camera, and/or other types of user input devices. In some implementations, the type of the user input device 102 can have a form factor associated with a type of the simulated object (e.g., a type of simulated object it is intended to control). By way of example, the user input device 102 can include a steering wheel for controlling the motion of a simulated vehicle within the simulated environment. In another example, the user input device 102 can include a handle bar for controlling the motion of a simulated bicycle or motorcycle within the simulated environment.

A user 108 (e.g., a test operator) can provide user input to the user input device to control the motion of the simulated object during a simulation run in real-time and/or at least near real-time (e.g., accounting for any processing delays between when the user input device 102 is manipulated and when the simulated object is moved within the simulated environment and/or when the movement is depicted via a user interface). The user 108 can provide user input by physically interacting with the user input device 102, providing a voice input to the user input device 102, making a motion with respect to the user input device 102 (e.g., a motion that can be sensed by the user input device 108, etc.), and/or otherwise providing user input. The user 108 can also provide user input to control other aspects of the simulated object. By way of example, the user 108 can provide user input to activate a simulated horn, lights (e.g., hazard lights, turn signal, etc.), and/or other components of a simulated vehicle. The user input device 102 can be configured to provide data 110 indicative of a user input associated with a motion of a simulated object and/or other aspects of the motion of the simulated object (e.g., to the simulation system 106).

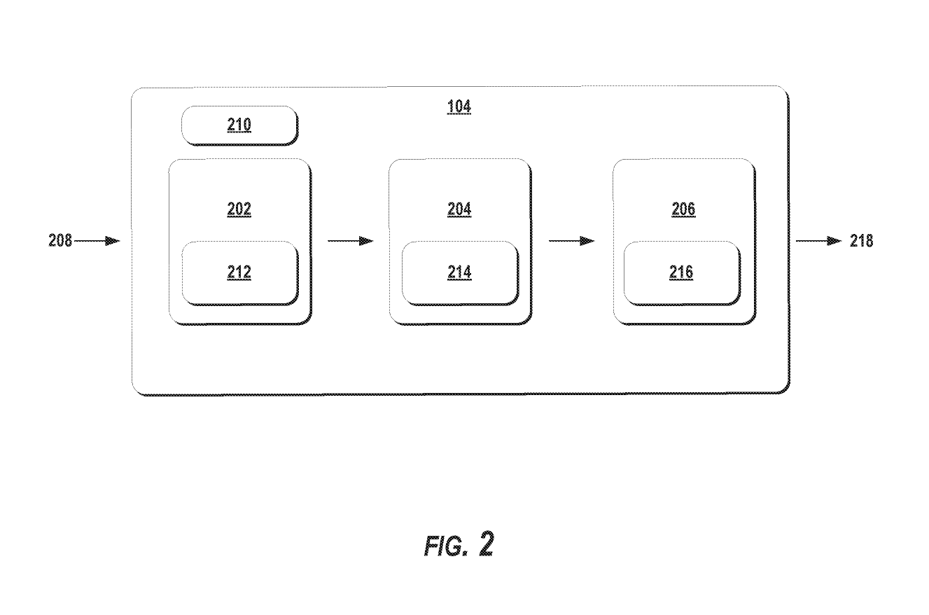

FIG. 2 depicts an overview of the autonomous vehicle computing system 104 according to example embodiments of the present disclosure. The autonomous vehicle computing system 104 can be configured to control a simulated autonomous vehicle (e.g., within a simulated environment). The autonomous vehicle computing system 104 can include an autonomy software stack that is the same as or at least similar to the software stack utilized on an autonomous vehicle (e.g., outside of a testing environment). In some implementations, the autonomy software stack utilized in the testing environment can also, or alternatively, include software (e.g., an updated version) that has not been deployed onto an autonomous vehicle.

The autonomous vehicle computing system 104 can include one or more computing devices. The computing device(s) can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the autonomous vehicle computing system 104 to perform operations and functions, such as those described herein for controlling an autonomous vehicle within a testing environment.

The autonomous vehicle computing system 104 utilized in the testing system 100 can include one or more of the components of an autonomy computing system that would be included in an autonomous vehicle that is acting outside of a simulated, testing environment (e.g., deployed in the real-world for a vehicle service) and/or additional components to be tested, if any. For example, the autonomous vehicle computing system 104 can include various sub-systems that cooperate to perceive the simulated environment and determine a motion plan for controlling the motion of the simulated autonomous vehicle. The autonomous vehicle computing system 104 can include a perception system 202, a prediction system 204, a motion planning system 206, and/or other systems that cooperate to perceive the simulated environment and determine a motion plan for controlling the motion of the autonomous vehicle. For example, the autonomous vehicle computing system 104 can receive input data 208, attempt to comprehend the simulated environment by performing various processing techniques on the input data 208 (and/or other data), and generate an appropriate motion plan through such a simulated environment. As further described herein, the input data 208 can include simulated sensor data and/or other input data.

In some implementations, in addition to the input data 208, the autonomous vehicle computing system 104 can obtain test map data 210. The test map data 210 can provide detailed information about the simulated environment. The test map data 210 can provide information associated with the simulated environment such as, for example: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); and/or any other test map data that provides information that assists the autonomous vehicle computing system 104 in comprehending and perceiving the simulated environment.

The autonomous vehicle computing system 104 can identify one or more simulated objects (e.g., within a simulated testing environment) that are proximate to the autonomous vehicle based at least in part on the input data 208 and/or the test map data 210. The autonomous vehicle computing system 104 can include a perception system 202 that can process the input data 208, test map data 210, etc. to generate perception data 212. The vehicle computing system 104 can obtain perception data 212 that is indicative of one or more states (e.g., current and/or past state(s)) of one or more simulated objects that are within a simulated environment. For example, the perception data 212 for each object can describe (e.g., for a given time, time period, etc.) an estimate of the object's: current and/or past location (also referred to as position); current and/or past speed/velocity; current and/or past acceleration; current and/or past heading; current and/or past orientation; size/footprint (e.g., as represented by a bounding shape); class (e.g., pedestrian class vs. vehicle class vs. bicycle class), the uncertainties associated therewith, and/or other state information. The perception system 202 can provide the perception data 212 to the prediction system 204.

The prediction system 204 can be configured to predict a motion of the simulated object(s) within the simulated environment. For instance, the prediction system 204 can create prediction data 214 associated with such object(s). The prediction data 214 can be indicative of one or more predicted future locations of one or more of the simulated object(s). The prediction data 214 can indicate a predicted path associated with each simulated object, if any. The predicted path can be indicative of a predicted object motion trajectory along which the respective simulated object is predicted to travel over time. The prediction data 214 can be indicative of the speed at which the simulated object is predicted to travel along the predicted path and/or a timing associated therewith. The prediction data 214 can be created iteratively at a plurality of time steps such that the predicted movement of the simulated objects can be updated, adjusted, confirmed, etc. over time. The prediction system 204 can provide the prediction data 214 associated with the simulated object(s) to the motion planning system 206.

The motion planning system 206 can determine a motion plan 216 for a simulated vehicle based at least in part on the prediction data 214 (and/or other data). The motion plan 216 can indicate how the simulated autonomous vehicle is to move through its simulated environment. The motion (e.g., the motion plan 216) of the simulated autonomous vehicle can be based at least in part on the motion of the simulated object(s). The motion plan 216 can include vehicle actions with respect to the simulated objects proximate to the simulated autonomous vehicle as well as the predicted movements. For instance, the motion planning system 216 can implement an optimization planner that includes an optimization algorithm, which considers cost data associated with a vehicle action as well as other objective functions (e.g., cost functions based on speed limits, traffic lights, etc.), if any, to determine optimized variables that make up the motion plan 216. By way of example, the motion planning system 206 can determine that a simulated autonomous vehicle can perform a certain action (e.g., pass an object) without increasing the potential risk to the vehicle and/or violating any traffic laws (e.g., simulated speed limits, lane boundaries, signage, etc.). A motion plan 216 can include a planned motion trajectory of the simulated autonomous vehicle. The planned motion trajectory can be indicative of a trajectory that the simulated autonomous vehicle is to follow for a particular time period. The motion plan 216 can also indicate speed(s), acceleration(s), and/or other operating parameters/actions of the simulated autonomous vehicle.

The motion planning system 206 can be configured to continuously update the vehicle's motion plan 216 and the corresponding planned motion trajectory. For example, in some implementations, the motion planning system 206 can generate new motion plan(s) (e.g., multiple times per second). Each new motion plan can describe motion of the simulated autonomous vehicle over the next several seconds (e.g., 5, 10, 15 seconds, etc.). Moreover, a new motion plan may include a new planned motion trajectory. Thus, in some implementations, the motion planning system 206 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed to control the motion of the simulated autonomous vehicle.

The autonomous vehicle computing system 104 can provide data 218 associated with the motion of the simulated autonomous vehicle within the simulated environment (and/or other data) to the simulation system 106. For example, the motion planning system 206 can output a motion plan 216 that describes an intended motion and/or trajectory of the simulated autonomous vehicle. While in real-world operation, an autonomous vehicle can typically include various components (e.g., one or more vehicle controllers) that control the autonomous vehicle to execute a motion plan. In some implementations, while in the simulated testing environment, the motion planning system 216 can provide data associated with the motion plan 216 of the simulated autonomous vehicle to the simulation system 106. The simulation system 106 can use the provided motion plan 216 to simulate the motion of the autonomous vehicle within the simulated environment. In some implementations, the autonomous vehicle computing system 104 (e.g., used in the offline testing) can include a vehicle controller system that simulates the functions of the vehicle controller(s). In such a case, the autonomous vehicle computing system 104 can provide, to the simulation system 106, data indicative of instructions determined by the vehicle controller system based at least in part on the motion plan 216. The simulation system 106 can control the simulated autonomous vehicle 104 based at least in part on the data indicative of the vehicle controller system instructions.

Returning to FIG. 1, the simulation system 106 can include one or more computing devices. The computing device(s) can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the autonomous vehicle computing system 104 to perform operations and functions, such as those described herein for testing autonomous vehicles (e.g., the software and computing systems utilized in autonomous vehicles).

The simulation system 106 can include various components and sub-systems to help run the testing simulation scenario(s) within a simulated environment. For instance, the simulation system 106 can include a user input device interface 112 that is configured to obtain data 110 indicative of user input via the user input device 102. The user input device interface 112 can process such data and provide it to a simulated object dynamics system 114 that is configured to control the dynamics of a simulated object within a simulated environment. For instance, the simulated object dynamics system 114 can control the motion of the simulated object based at least in part on the motion indicated by the data 110 indicative of the user input.

The simulation system 106 can include a sensor data renderer 116 that is configured to render simulated sensor data associated with the simulated environment. This can include, for example, simulated image data, Light Detection and Ranging (LIDAR) data, Radio Detection and Ranging (RADAR) data, and/or other types of data. The simulated sensor data can be indicative of the simulated object within the simulated environment of the simulated autonomous vehicle. This can include, for instance, simulated sensor data indicative one or more locations of the simulated object(s) within the simulated environment at one or more times.

The simulation system 106 can provide simulated sensor data to the autonomous vehicle computing system 104, for example, as input data 208. The autonomous vehicle computing system 104 can process the simulated sensor data associated with the simulated environment in a manner that is similar to how an autonomous vehicle would process sensor data associated with a real-world environment. For instance, the autonomous vehicle computing system 104 can be configured to process the simulated sensor data to detect one or more simulated objects that are within the simulated environment based at least in part on the simulated sensor data. The autonomous vehicle computing system 104 can predict the motion of the simulated object(s), as described herein. The autonomous vehicle computing system 104 can generate an appropriate motion plan 216 through the simulated environment, accordingly. As described herein, the autonomous vehicle computing system 104 can provide data 218 indicative of the motion of the simulated autonomous vehicle to a simulation system 106 in order to control the simulated autonomous vehicle within the simulated environment.

The simulation system 106 can also include a simulated vehicle dynamics system 118 configured to control the dynamics of the simulated autonomous vehicle within the simulated environment. For example, in some implementations, the simulated vehicle dynamics system 118 can control the simulated autonomous vehicle within the simulated environment based at least in part on the motion plan 216 determined by the autonomous vehicle computing system 104. The simulated vehicle dynamics system 118 can translate the motion plan 216 into instructions and control the simulated autonomous vehicle accordingly. In some implementations, the simulated vehicle dynamics system 118 can control the simulated autonomous vehicle within the simulated environment based at least in part on instructions determined by the autonomous vehicle computing system 104 (e.g., a simulated vehicle controller). In some implementations, the simulated vehicle dynamics system 118 can be programmed to take into account certain dynamics of a vehicle. This can include, for example, processing delays, vehicle structural forces, travel surface friction, and/or other factors to better simulate the implementation of a motion plan on an actual autonomous vehicle.

The simulation system 106 (e.g., the simulated vehicle dynamics system 118) can include and/or otherwise communicate with an interface 119. The interface 119 can enable the simulation system 106 to receive data and/or information from a separate computing system such as, for example, the autonomous vehicle computing system 104. For instance, the interface 119 can be configured to communicate with one or more processors (e.g., second processor(s)) that implement and/or are designated for the autonomous vehicle computing system 104. These processor(s) can be different from the one or more processors (e.g., first processor(s)) that implement and/or are designated for the simulation system 106. The simulation system 106 can obtain, via the interface 119, an output from the autonomous vehicle computing system 104. The output can include data associated with a motion of the simulated autonomous vehicle. The motion of the simulated autonomous vehicle can be based at least in part on the motion of the simulated object, as described herein. For example, the output can be indicative of one or more command signals from the autonomous vehicle computing system 104. The one or more command signals can be indicative of the motion of the simulated autonomous vehicle. In some implementations, the command signal(s) can be based at least in part on the motion plan 216 generated by the autonomous vehicle computing system 104 for the simulated autonomous vehicle. The motion plan 216 can be based at least in part on the motion of the simulated object (e.g., to avoid colliding with the simulated object), as described herein. The command signal(s) can include instructions to implement the determined motion plan. In some implementations, the output can include data indicative of the motion plan 216 and the simulation system can translate the motion plan 216 to control the motion of the simulated autonomous vehicle.

The simulation system 106 can control the motion of the simulated autonomous vehicle within the simulated environment based at least in part on the output from the autonomous vehicle computing system that is obtained via the interface 119. For instance, the simulation system 106 can obtain, via the interface 119, the command signal(s) from the autonomous vehicle computing system 104. The simulation system 106 can model the motion of the simulated autonomous vehicle within the simulated environment based at least in part on the command signal(s). In this way, the simulation system 106 can utilize the interface 119 to obtain data indicative of the motion of the simulated autonomous vehicle from the autonomous vehicle computing system 104 and control the simulated autonomous vehicle within the simulated environment, accordingly.

The simulation system 106 can include a scenario recorder 120 and a scenario playback system 122. The scenario recorder 120 can be configured to record data associated with the initial input(s) as well as data associated with a simulated object and/or the simulated environment before, during, and/or after the simulation is run. The scenario recorder 120 can provide data for storage in an accessible memory 124 (e.g., a scenario memory). The memory 124 can be local to and/or remote from the testing system 100, simulation system 106, etc. The scenario playback system 122 can be configured to retrieve data from the memory 124 for a future simulation. For example, the scenario playback system 122 can obtain data indicative of a simulated object (and its motion) in a first simulation for use in a subsequent simulation, as further described herein.

In some implementations, the simulation system 106 (e.g., the scenario playback system 122) can utilize data indicative of simulated environments and/or testing scenarios submitted by a third party. For instance, a third party system 125 can provide data indicative of a third party simulated environment and/or testing scenario 127. A third party simulated environment and/or testing scenario 127 can be generated by the third party system 125 and/or a third party (e.g., different than an entity that operates the simulation system 106). In some implementations, the third party system 125 can provide data indicative of one or more third party simulated environments and/or testing scenarios 127 for storage in the memory 124. The simulation system 106 can obtain data indicative of the third party simulated environments and/or testing scenarios 127 from the memory 124. In some implementations, the simulation system 106 can obtain data indicative of the third party simulated environments and/or testing scenarios 127 from another memory (e.g., a third party database that stores the third party simulated environments and/or testing scenarios 127.

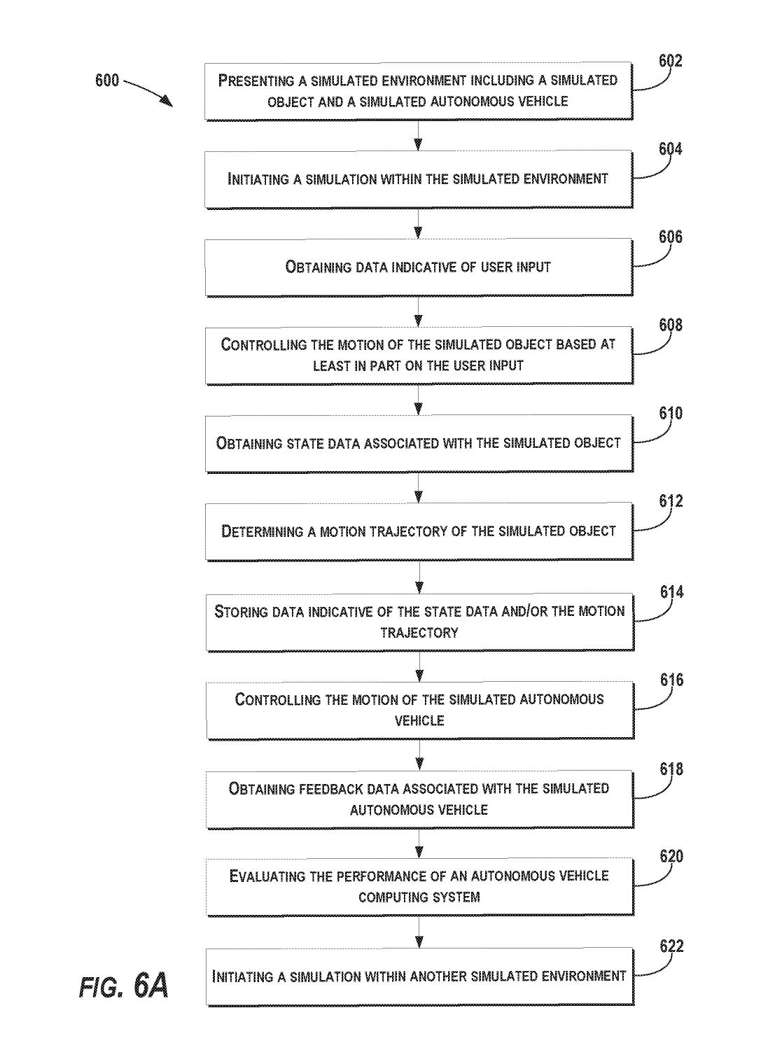

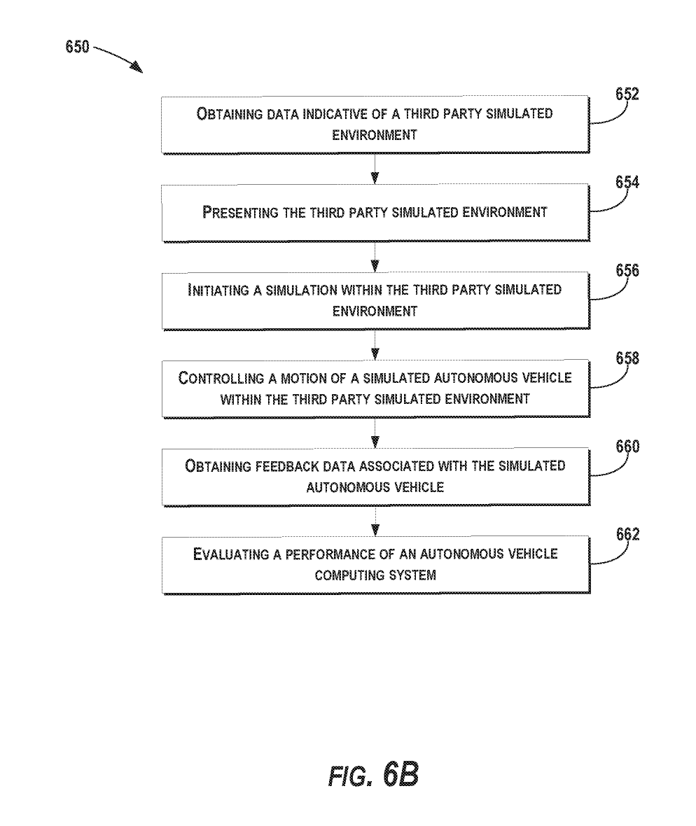

The simulation system 106 can be configured to generate a simulated environment and run a test simulation within that simulated environment. For instance, the simulation system 106 can obtain data indicative of one or more initial inputs associated with the simulated environment. For example, a user 108 can specify (e.g., via the same and/or one or more different user input devices) various characteristics of the simulated environment that include, for example: a general type of geographic area for the simulated environment (e.g., highway, urban, rural, etc.); a specific geographic area for the simulated environment (e.g., beltway of City A, downtown of City B, country side of County C, etc.); one or more geographic features (e.g., trees, benches, obstructions, buildings, boundaries, exit ramps, etc.) and their corresponding positions in the simulated environment; a time of day; one or more weather conditions; one or more initial conditions of the simulated object(s) within the simulated environment (e.g., initial position, heading, speed, etc.); a type of each simulated object (e.g., vehicle, bicycle, pedestrian, etc.); a geometry of each simulated object (e.g., shape, size etc.); one or more initial conditions of the simulated autonomous vehicle within the simulated environment (e.g., initial position, heading, speed, etc.); a type of the simulated autonomous vehicle (e.g., sedan, sport utility, etc.); a geometry of the simulated autonomous vehicle (e.g., shape, size etc.); operating condition of each simulated object (e.g., correct turn signal usage vs. no turn signal usage, functional brake lights vs. one or more brake lights that are non-functional, etc.) and/or other data associated with the simulated environment. In some implementations, the simulation system 106 can automatically determine the initial inputs without user input. For example, the simulation system 106 can determine one or more initial inputs based at least in part on one or more previous simulation runs, simulated environments, simulated object(s), etc. The simulation system 106 can obtain the data indicative of the initial input(s). The simulation system 106 can generate the simulated environment based at least in part on the data indicative of the initial input(s). In some implementations, one or more templates can be available for selection, which provide a standardized or otherwise pre-configured simulated environment and the user 108 can select one of the templates and optionally modify the template environment with additional user input. In some implementations, the simulation system 106 can generate a third party simulated environment 127 based at least in part on the data provided by the third party system 125, as further described herein with reference to FIG. 6B.

The simulation system 106 can present a visual representation of a simulated environment via a user interface on one or more display devices 126 (e.g., display screen(s), etc.). The simulated environment can include one or more simulated objects and a simulated autonomous vehicle (e.g., as visual representations on the user interface).

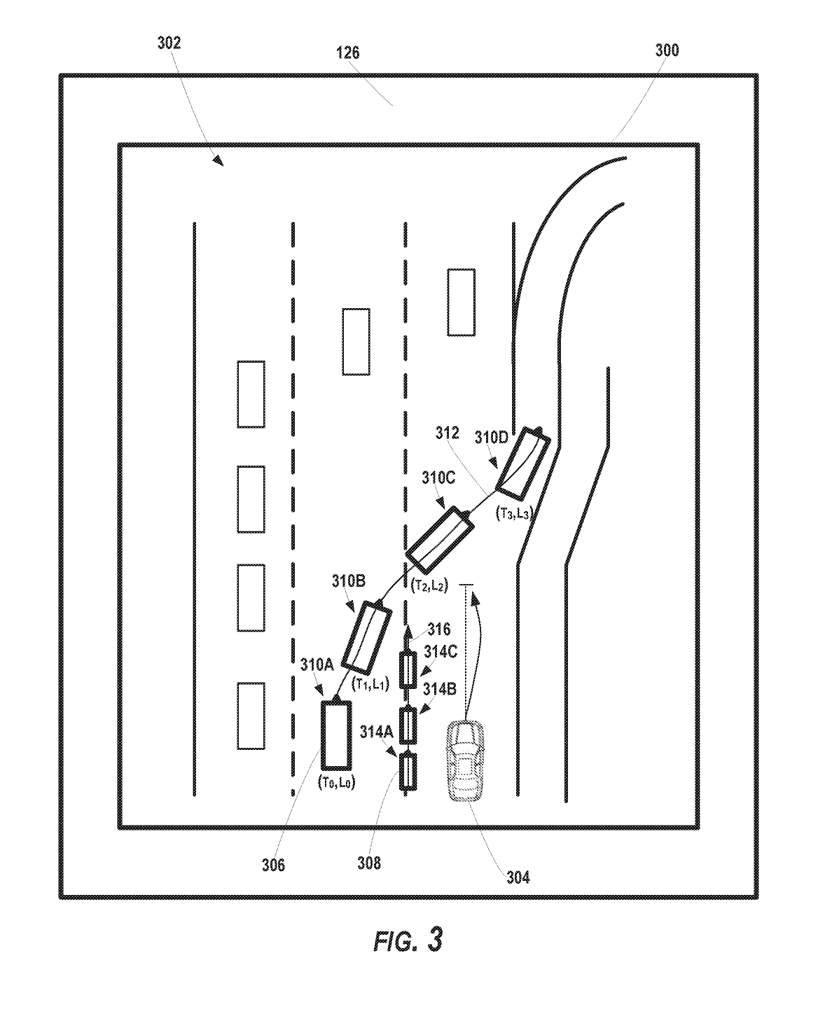

For example, FIG. 3 depicts an example user interface 300 presenting an example simulated environment 302 according to example embodiments of the present disclosure. The user interface 300 can be presented via the one or more display devices 126. The simulated environment 302 can be a highway environment in which a simulated autonomous vehicle 304 is travelling in a traffic lane adjacent to a first simulated object 306 (e.g., a simulated vehicle) and/or a second simulated object 308.

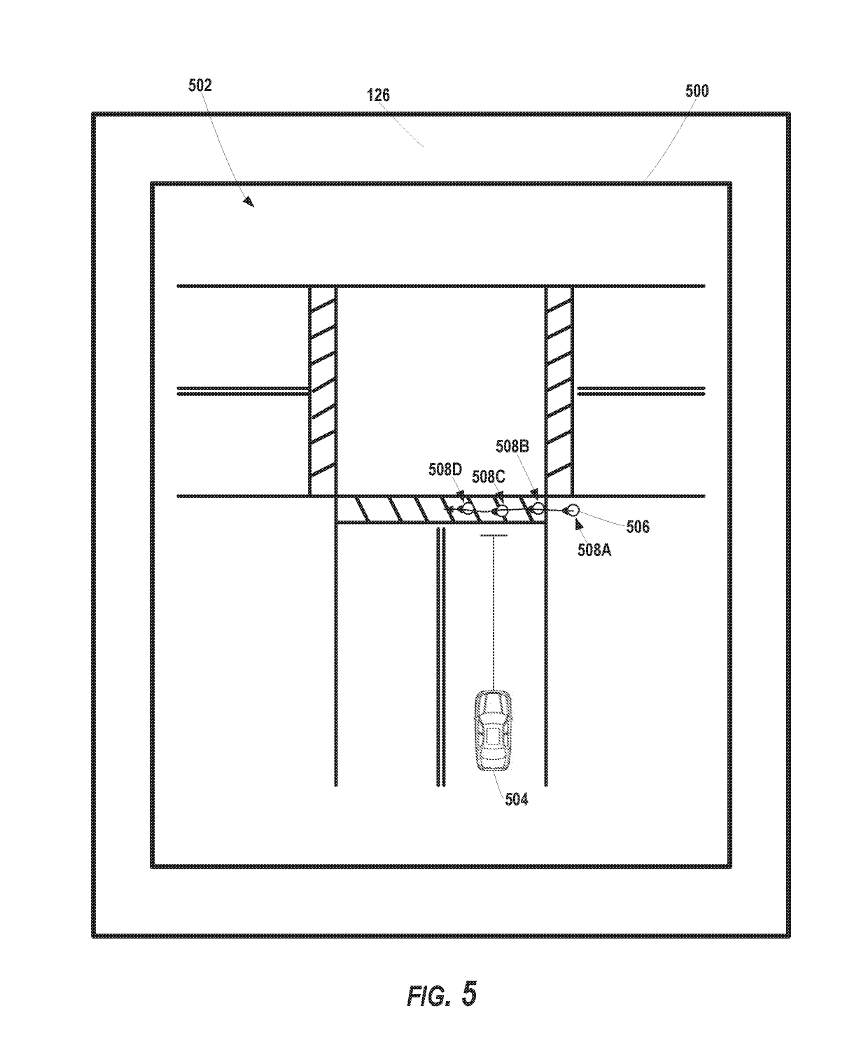

In another example, FIG. 5 depicts an example user interface 500 presenting another example simulated environment 502 according to example embodiments of the present disclosure. The simulated environment 502 can be an urban intersection environment in which a simulated autonomous vehicle 504 is travelling along a travel way that approaches a crosswalk. A simulated object 506 (e.g., a simulated pedestrian) can be positioned near the crosswalk.

The simulation system 106 and display device(s) 126 can operate to provide various different views of a simulated environment including, as examples, a bird's eye or overhead view of the simulated environment, a view rendered from the vantage point of the object (e.g., from the driver's seat of the simulated object), a view rendered from the vantage point of the simulated autonomous vehicle, and/or other views of the simulated environment.

Returning to FIG. 1, the simulation system 106 (e.g., via a user input device interface 112) can obtain data 110 indicative of a user input associated with a motion of a simulated object within the simulated environment. For instance, the simulation system 106 can initiate a simulation associated with the simulated environment. Such initiation can cause, for example, any simulated objects and/or the simulated autonomous vehicle to act in accordance with the initial input(s)/condition(s). Additionally, initiation of the simulation run can initiate any weather condition(s) and/or other conditions of the simulation. While the simulation is running, the user input can be provided, via the user input device 102, by the user 108 (e.g., test operator that is viewing the simulated environment on the user interface). During the simulation run, the simulation system 106 can obtain data 110 indicative of a user input associated with a motion of the simulated object within the simulated environment. In response to the user input and during the simulation run, the simulation system 106 can control the motion of the simulated object within the simulated environment based at least in part on the data 110 indicative of the user input. For instance, during the simulation run, the simulation system 106 can move the simulated object within the simulated environment in accordance with the user input. The simulation system 106 can provide data for display via the display device(s) 126 such that movement of the simulated object(s) can be presented on the user interface (e.g., in real-time, at least near real-time, etc.). This can allow the user 108 to view the movement of the simulated object as controlled by the user 108.

By way of example, with reference to FIG. 3, the user 108 can manipulate a user input device 102 (e.g., a steering wheel) to control the first simulated object 306 (e.g., a simulated vehicle) to cut-off the simulated autonomous vehicle 304 in the simulated environment 302 (e.g., to reach an exit ramp). As the user 108 manipulates the user input device 102, the visual representation of the simulated object 306 on the user interface 300 can move within the simulated environment 302 (e.g., the across lanes in a simulated highway). Additionally or alternatively, the user 108 can manipulate a user input device 102 (e.g., handle bar) to control a second simulated object 308 (e.g., a simulated motorcycle) to split a traffic lane boundary adjacent to the simulated autonomous vehicle 304. The simulation system 106 can cause a visual representation of the second simulated object 308 to move accordingly within the simulated environment 302 presented via the user interface 300.

The simulation system 106 (e.g., the simulated data renderer 116) can provide simulated sensor data to the autonomous vehicle computing system 104. The simulated sensor data can be indicative of the position(s) of the first and/or second simulated objects 306, 308 within the simulated environment 302. The autonomous vehicle computing system 104 can process the simulated sensor data to perceive the simulated object(s) 306, 308 and predict a motion of the simulated object(s), as described herein. The autonomous vehicle computing system 104 can plan the motion of the simulated autonomous vehicle 304 within the simulated environment 302. The motion (e.g., the motion plan 216) of the simulated autonomous vehicle 304 can be based at least in part on the motion of the simulated object 306, 308. For example, the autonomous vehicle computing system 104 can plan the motion of the simulated autonomous vehicle 304 in order to avoid the first simulated object 306 (e.g., that cut-off the simulated autonomous vehicle 304) by decelerating, stopping, changing lanes, pulling over, etc. Additionally, or alternatively, the autonomous vehicle computing system 104 can plan the motion of the simulated autonomous vehicle 304 to avoid the second simulated object 308 (e.g., that split the lane adjacent to the simulated autonomous vehicle 304) by nudging, stopping, changing lanes, pulling over, etc.

The autonomous vehicle computing system 104 can provide data associated with the motion of the simulated autonomous vehicle 304 (e.g., data associated with a motion plan 216 of the simulated autonomous vehicle 304) to the simulation system 106. The simulation system 106 (e.g., the simulated vehicle dynamics system 118) can obtain, from the autonomous vehicle computing system, the data associated with the motion (e.g., a motion plan 216) of the simulated autonomous vehicle 304. The simulation system 106 can control a motion of the simulated autonomous vehicle 304 within the simulated environment 302 based at least in part on the data associated with the motion (e.g., the motion plan) of the simulated autonomous vehicle 304. For example, the simulation system 106 can cause the simulated autonomous vehicle 304 to decelerate, nudge, stop, change lanes, pull over, etc. within the simulated environment 302.

In another example, with reference to FIG. 5, the user input can control a simulated object 506 (e.g., a simulated pedestrian) to travel within a simulated environment 502 (e.g., to cross a crosswalk). The simulation system 106 (e.g., the user input device interface 112) can obtain data 110 indicative of the user input associated with the motion of the simulated object 506 (e.g., a simulated pedestrian). The simulation system 106 can control the motion of the simulated object 506 within the simulated environment 502 in at least near real-time based at least in part on the data 110 indicative of the user input. As the user 108 provides user input to the user input device 102, the visual representation of the simulated object 506 on the user interface 500 can move within the simulated environment 302 (e.g., the across cross-walk). The simulation system 106 can receive data indicative of the motion of the simulated autonomous vehicle 504 (e.g., from the autonomous vehicle computing system 104) and control the motion of the simulated autonomous vehicle 504 accordingly. The motion of the simulated autonomous vehicle 504 can be based at least in part on the motion of the simulated object 502. For example, the simulated autonomous vehicle 504 can decelerate to a stopped position before the cross-walk to allow the simulated object 502 (e.g., the simulated pedestrian) to cross the travel way.

The simulation system 106 can obtain state data indicative of one or more states of a simulated object within a simulated environment. For instance, with reference again to FIG. 3, the simulation system 106 can obtain state data indicative of one or more states 310A-D of the first simulated object 306 within the simulated environment 302. As the first simulated object 306 moves within the simulated environment 302 during a simulation run, the simulation system 106 (e.g., the scenario recorder 120) can obtain state data indicative of one or more states 310A-D of the simulated object 306 at one or more times. The state(s) 310A-D can be indicative of the position(s), heading(s), speed(s), and/or other information of the first simulated object 306 within the simulated environment 302 at the one or more times.

The simulation system 106 can obtain data indicative of a motion trajectory of a simulated object within the simulated environment. For instance, simulation system 106 can obtain state data indicative of the state(s) 310A-D of the first simulated object 306 within the simulated environment 302, as described herein. The simulation system 106 can determine the motion trajectory 312 of the first simulated object 306 based at least in part on the one or more states 310A-D of the first simulated object 306 within the simulated environment 302. For instance, the simulation system 106 can trace and/or track the state(s) 310A-D to determine a motion trajectory 312 of the first simulated object 306 that corresponds to the motion of the first simulated object 306 within the simulated environment 302.

The state(s) of a simulated object can be parameterized with respect to the simulated environment such that they are flexible across a variant of simulations. For instance, the simulation system 106 can parameterize the one or more states into parameter data associated with the simulated environment. The parameter data can be indicative of a relationship between the simulated object and the simulated environment 302. For instance, the state(s) can be parameterized into parameter data (e.g., indicative one or more parameters) within the context of the simulated environment (e.g., with respect to the simulated autonomous vehicle). This can allow the motion trajectory of the simulated object to be easily reproduced in a subsequent simulation. The parameter data can be indicative of a relationship (e.g., spatial relationship, temporal relationship, etc.) between the simulated object and the simulated environment (e.g., and/or the simulated autonomous vehicle 304). The parameter(s) can include metadata such as, for example, the relative distance between the simulated object and the simulated autonomous vehicle, the relative distance between the simulated object and another feature of the simulated environment (e.g., lane boundary, stop sign, exit ramp, cross walk, etc.), temporal parameters (e.g., the time it would take for the simulated autonomous vehicle to reach the first simulated object, etc.), the velocity of the simulated autonomous vehicle when the simulated object reaches a certain state, and/or other parameters.

By way of example, with reference to FIG. 3, the simulation system 106 can parameterize the state(s) 310A-D of the first simulated object 306 with respect to the simulated environment 302 (e.g., the simulated highway) based on the distance between the first simulated object 306 and the simulated autonomous vehicle 304, the headway of the simulated autonomous vehicle 304, the speed of the simulated autonomous vehicle 304, etc. as the simulated object 302 cuts-off the simulated autonomous vehicle 304. In another example, with reference to FIG. 5, the simulation system 106 can parameterize one or more states 508A-D of the simulated object 506 (e.g., a simulated pedestrian crossing a crosswalk) based on the distance between the simulated autonomous vehicle 504 and the crosswalk and/or other parameter(s).

In some implementations, the simulation system 106 can obtain data indicative of one or more labels identifying which parameters (e.g., metadata) should be recorded by the simulation system 106. The user 108 can provide user input indicative of the label(s) to the simulation system 106 (e.g., via the user input device 102, another user input device, etc.) before, during, and/or after a simulation. Thus, the user 108 can control which parameter(s) are generated and/or recorded for each simulated object before, during, and/or after the simulation is conducted. For example, in some implementations, an additional user input can be used to control a timing at which each label should be marked during the simulation. The user 108 can provide user input (e.g., by pressing a button, etc.) indicating that the simulation system 106 should obtain data indicative of parameters at a first time, a second time, etc. In response, the simulation system 106 can obtain the parameters at these times.

Returning to FIG. 1, the simulation system 106 can store, in the accessible memory 124, at least one of the state data 128 indicative of the one or more states of the simulated object and/or data 130 indicative of the motion trajectory of the simulated object within the simulated environment. The simulation system 106 can store the state data 128 and/or the data 130 indicative of the motion trajectory of the simulated object in raw or parameterized form. The memory 124 (e.g., a scenario memory) can include one or more memory devices that are local to and/or remote from the simulation system 106. The memory can be a library database that includes state data 128 and/or motion trajectories of a plurality of simulated objects (e.g., generated based on user input) from a plurality of simulations (e.g., previously run simulations).

The state data 128 and/or the data 130 indicative of motion trajectories of simulated objects can be accessed, viewed, and/or selected for use in a subsequent simulation. For instance, the simulation system 106 can generate a second simulation environment for a second simulation. The second simulation environment can be similar to and/or different from a previous simulation environment (e.g., a similar or different simulated highway environment). The simulation system 106 can present the second simulated environment via a user interface on the one or more display device(s) 126. The simulation system 106 can obtain (e.g., from the memory 124) the state data 128 indicative of the state(s) (e.g., in raw or parameterized form) of a simulated object and/or the data 130 indicative of a motion trajectory of the simulated object within the first simulated environment. The simulation system 106 can control a second motion of the simulated object within the second simulated environment based at least in part on the state(s) and/or the motion trajectory of the simulated object within the first simulated environment.

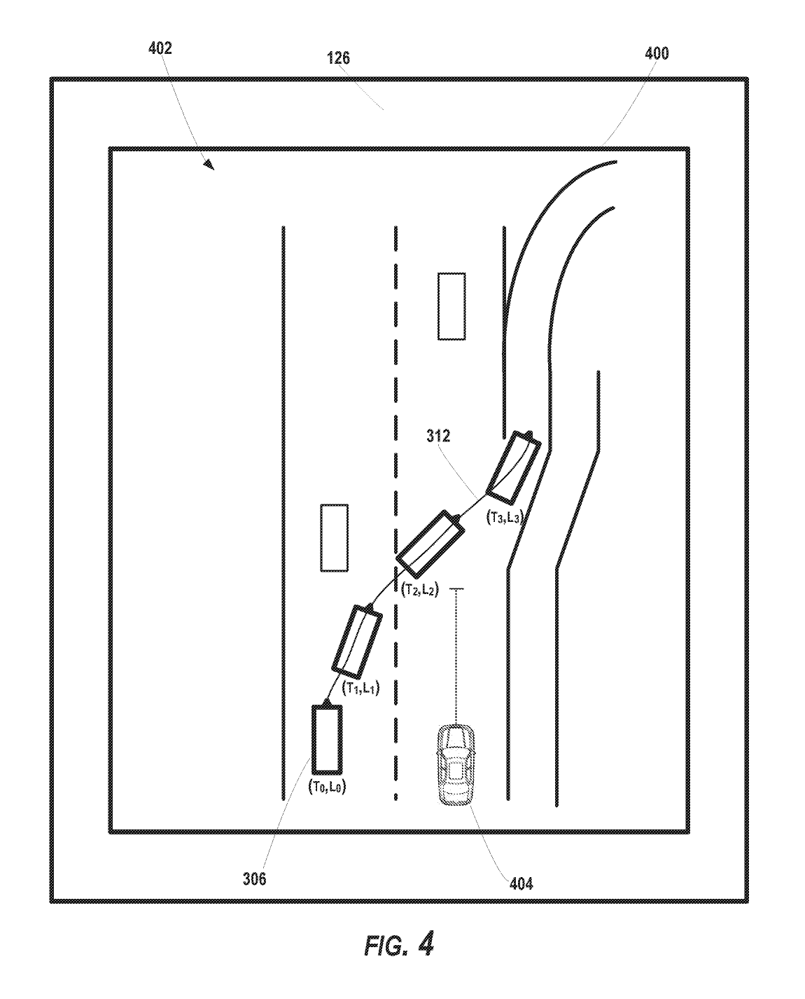

For instance, with reference to FIGS. 3 and 4, the cut-off maneuver of the first simulated object 306 within the first simulated environment 302 can be reproduced for a another simulation. The simulation system 106 can present a second simulated environment 402 via a user interface 400 on one or more display devices 126 (as shown in FIG. 4). The user interface 400 can be a second user interface and can be the same as or different from the user interface 300 (e.g., a first user interface presenting the first simulated environment 302). The simulation system 106 can obtain data 130 indicative of the motion trajectory 312 (e.g., a first motion trajectory) of the first simulated object 306 within the first simulated environment 302. The simulation system 106 can configure a second simulation with the second simulated environment 402 including the first simulated object 306 and a simulated autonomous vehicle 404, which can be controlled by the same or different autonomous vehicle computing system as the simulated autonomous vehicle 304 in the first simulated environment 302. The simulated object within the second simulated environment 402 can be the same as or different from the simulated object in the first simulated environment 302 (e.g., same or different type, same or different rendered object, etc.). The simulation system 106 can control a second motion of the simulated object 306 within the second simulated environment 402 based at least in part on the motion trajectory 312 of the simulated object 306 within the first simulated environment 302. For instance, the simulated object 306 within the second simulated environment 402 can follow the same motion trajectory 312 as in the first simulated environment 302. This can allow the motion of the simulated object 306 to be incorporated across a variety of simulations to test the autonomy software stack.

In some implementations, at least one of the one or more parameters can be utilized to initiate (at least a portion of) the motion of the simulated object 306 within the second simulated environment 402. For example, the motion of the simulated object 306 within the second simulated environment 402 (e.g., the cut-off maneuver) can be initiated when the simulated autonomous vehicle 404 is at a certain distance from the simulated object 306, at a certain position, at a certain relative speed, etc. within the second simulated environment 402. In this way, parameterization of the previously collected state data 128 associated with the simulated object 306 can help enable the motion trajectory 312 of the simulated object 306 from one simulation to be leveraged for a subsequent simulation.

Returning to FIG. 1, the simulation system 106 can obtain feedback data 132 associated with the autonomous vehicle computing system 104. For example, the simulation system 106 can obtain the data generated by the autonomous vehicle computing system 104 as it attempts to perceive and predict the motion of a simulated object, plan motion, and navigate a simulated autonomous vehicle within a simulated environment. Such data can be generated during a simulation run. For instance, the feedback data 132 can be indicative of at least one of the perception data 212 associated with the simulated object, the prediction data 214 associated with the simulated object, and/or data associated with a motion plan 216 associated with the simulated autonomous vehicle. The simulation system 106 can obtain the perception data 212 associated with the simulated object, the prediction data 214 associated with the simulated object, and/or the motion planning data associated with the simulated autonomous vehicle (e.g., from the vehicle autonomy system 104). Additionally, or alternatively, the feedback data 132 can include a trajectory of the simulated autonomous vehicle as it navigates through the simulated environment. Additionally, or alternatively, the feedback data 132 can include data indicative of instructions (e.g., for simulated vehicle motion) determined by the autonomous vehicle computing system 104 (e.g. a simulated vehicle controller), as described herein.

The simulation system 106 can evaluate the feedback data 132 to determine the performance of the autonomous vehicle computing system 104 during a simulation. For instance, the simulation system 106 can compare the state data 128 of the simulated object to the perception data 212 to determine whether the autonomous vehicle computing system 104 accurately perceived the state(s) 310A-D of the first simulated object 306. Additionally, or alternatively, the simulation system 106 can compare the motion trajectory 312 of the first simulated object 306 to the prediction data 216 to determine whether the autonomous vehicle computing system 104 has accurately predicted the motion of the first simulated object 306. The simulation system can also, or alternatively, compare the motion plan 216 and/or the motion trajectory of the simulated autonomous vehicle 304 to the motion trajectory 312 of the first simulated object 306 to determine whether the autonomous vehicle computing system 104 appropriately planned and controlled the motion of the simulated autonomous vehicle 304 (e.g., to avoid collision with the first simulated object 306). As another example, the acceleration and/or jerk associated with the simulated autonomous vehicle behavior can be measured, for example, to assess a degree of comfortability that would be experienced by a passenger of the simulated autonomous vehicle 304.

In some implementations, a plurality of user controlled simulated objects can be included in a simulated environment. In some implementations, a user 108 (e.g., a test operator) can build the simulation scenario using an iterative, layered approach. For example, with reference to FIG. 3, the user 108 can provide a first user input to control a first simulated object 306 (e.g., a simulated vehicle) during a first simulation run (e.g., at a first time period). Moreover, during the first simulation run, the simulation system 106 can obtain state data 128 associated with the first simulated object 306 and store data indicative of a first motion trajectory 312 of the first simulated object 306 in the memory 124, as described herein. The user 108 can provide a second user input to control a second simulated object 308 (e.g., a simulated motorcycle) during a second simulation run of the same simulated environment 302 (e.g., at a second, subsequent time period). The simulation system 106 can obtain data indicative of the second user input associated with the motion of the second simulated object 308 within the simulated environment 302. The simulation system 106 can control the motion of the second simulated object 308 within the simulated environment 302 based at least in part on the data indicative of the second user input.

The simulation system 106 can obtain state data 128 associated with the second simulated object 308. Such state data 128 can be indicative of one or more states 314A-C of the second simulated object 308 within the simulated environment 302 during the second simulation run associated with the simulated environment 302. The simulation system 106 can determine a motion trajectory 316 of the second simulated object 308 based at least in part on the one or more states 314A-C of the second simulated object 308 within the simulated environment 302. The simulation system 106 can store (e.g., in the memory 124) at least one of the state data 128 indicative of the one or more states 314A-C of the second simulated object 308 and/or data 130 indicative of the motion trajectory 316 of the second simulated object 308.

In some implementations, as the user 108 is providing the second user input to control the second simulated object 308, the first simulated object 306 can move within the simulated environment 302 according to the first motion trajectory 312. In this way, the simulation system 106 can iteratively create the motion trajectories of the simulated objects within a simulation. In some implementations, more than one user can utilize the testing system 100. For example, a first user 108 (e.g., a first test operator) can control the motion of the first simulated object 306 and a second user 134 (e.g., a second test operator) can control the motion of the second simulated object 308 (e.g., using a second user input device).

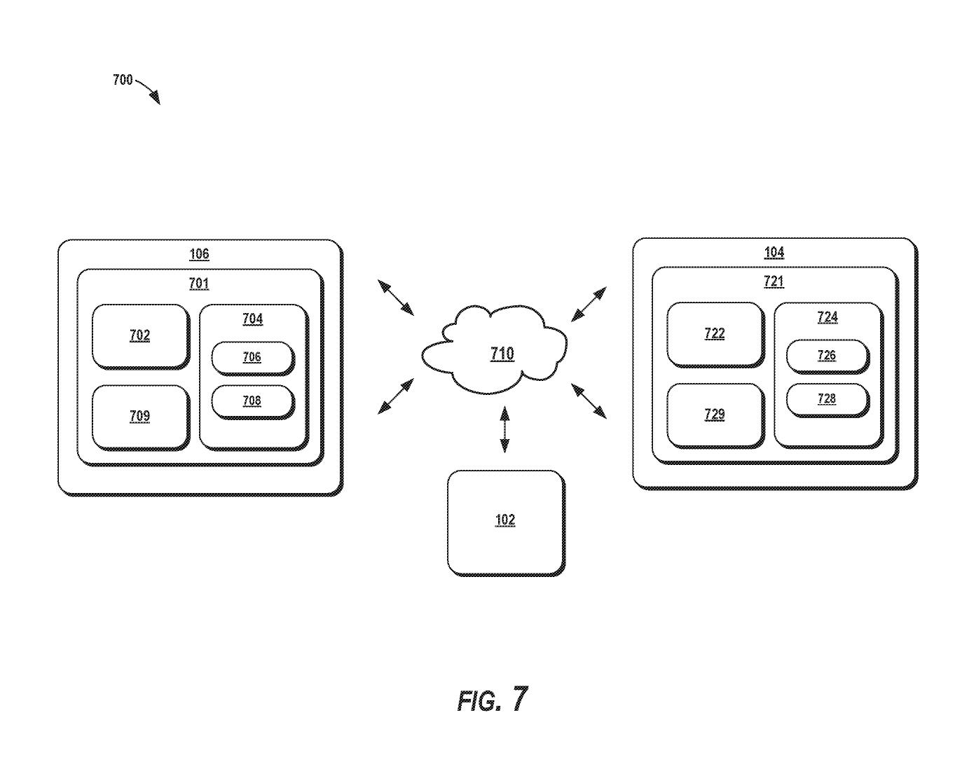

FIG. 6A depicts a flow diagram of another example method 600 for testing autonomous vehicles according to example embodiments of the present disclosure. One or more portion(s) of the method 600 can be implemented by one or more computing devices such as, for example, the one or more computing device(s) of the simulation system 106 and/or other systems. Each respective portion of the method 600 can be performed by any (or any combination) of the one or more computing devices. Moreover, one or more portion(s) of the method 600 can be implemented as an algorithm on the hardware components of the device(s) described herein (e.g., as in FIGS. 1 and 7). FIG. 6A depicts elements performed in a particular order for purposes of illustration and discussion and is not meant to be limiting.

At (602), the method 600 can include presenting a simulated environment that includes a simulated object and a simulated autonomous vehicle. For instance, the simulation system 106 can present a visual representation of a simulated environment 302 via a user interface 300 on a display device 126. As described herein, the simulated environment 302 can include a simulated object 302 and a simulated autonomous vehicle 304. In some implementations, the simulated environment 302 can include a plurality of simulated objects. For instance, the simulated environment 302 can include a first simulated object 306 and a second simulated object 308.

At (604), the method 600 can include initiating a simulation within the simulated environment. The simulation system 106 can initiate a simulation run associated with the simulated environment 302 (e.g., a first simulation run associated with the simulation environment 302). As such, the simulation system 106 can start the simulation within the simulated environment 302. The simulated object(s) and/or other features of the simulated environment can act (or remain static) according to any initial input(s)/condition(s). The simulation run can occur during a first time period and start at a first time.

At (606), the method 600 can include obtaining data indicative of user input. For instance, during the simulation run, the simulation system 106 can obtain data 110 indicative of a user input associated with a motion of a simulated object (e.g., the first simulated object 306) within the simulated environment 306. In some implementations, the simulation system 106 can obtain data indicative of a second user input associated with a motion of the second simulated object 308 within the simulated environment 302.

At (608), the method 600 can include controlling the motion of the simulated object based at least in part on the user input. For instance, in response to the user input and during the simulation run (e.g., the first simulation run), the simulation system 106 can control the motion of a simulated object (e.g., the first simulated object 306) within the simulated environment 302 based at least in part on the data 110 indicative of the user input. Moreover, the simulation system 106 can control the motion of the second simulated object 308 within the simulated environment 302 based at least in part on the data indicative of the second user input.

At (610), the method 600 can include obtaining state data associated with the simulated object. For instance, the simulation system 106 can obtain state data 128 indicative of one or more states 310A-D of the first simulated object 306 within the simulated environment 302. The state data 128 indicative of the one or more states 310A-D of the first simulated object 306 can be is obtained during the first time period associated with the first simulation run. The simulation system 106 can obtain state data 128 indicative of one or more states 314A-C of the second simulated object 308 within the simulated environment 302 during a second simulation run associated with the simulated environment 302. The second simulation run can occur at a second time period that is subsequent to the first time period.

The simulation system 106 can parameterize the one or more states into parameter data associated with the simulated environment 302. The parameter data can be indicative of a relationship between the simulated object 306, 308 and the simulated environment 302. In some implementations, at least one of the one or more parameters can be utilized to initiate at least a portion of a second motion of the simulated object 306 within a second simulated environment 402, as described herein.

At (612), the method 600 can include determining a motion trajectory of the simulated object. For instance, the simulation system 106 can determine a motion trajectory 312 of the simulated object (e.g., the first simulated object 306) based at least in part on the one or more states 310A-D. Additionally, or alternatively, the simulation system 106 can determine a motion trajectory 316 of the second simulated object 308 based at least in part on the one or more states 314A-C of the second simulated object 308 within the simulated environment 302.

At (614), the method 600 can include storing data indicative of the state data and/or the motion trajectory. For instance, the simulation system 106 can store, in an accessible memory 124, at least one of the state data 128 indicative of the one or more states 310A-D of the simulated object (e.g., the first simulated object 306) and/or data 130 indicative of the motion trajectory 312 of the simulated object (e.g., the first simulated object 306). Additionally, or alternatively, the simulation system 106 can store, in the accessible memory 124, at least one of the state data 128 indicative of the one or more states 314A-C of the second simulated object 308 and/or data 130 indicative of the motion trajectory 316 of the second simulated object 308.

At (616), the method 600 can include controlling the motion of the simulated autonomous vehicle. For instance, the simulation system 106 can obtain (e.g., from the autonomous vehicle computing system 104) data associated with the motion of the simulated autonomous vehicle 304 (e.g., data indicative of a motion plan 316 of the simulated autonomous vehicle 304). The motion (e.g., the motion plan 216) of the simulated autonomous vehicle 304 can be based at least in part on the motion of one or more simulated objects (e.g., the first simulation object 306, the second simulated object 308, etc.). The simulation system 106 (e.g., the simulated vehicle dynamics system 118) can control a motion of the simulated autonomous vehicle 304 within the simulated environment 302 based at least in part on the data associated with the motion of the simulated autonomous vehicle (e.g., data associated with the motion plan 216).

At (618), the method 600 can include obtaining feedback data associated with the simulated autonomous vehicle. The simulation system 106 obtain feedback data 132 associated with an autonomous vehicle computing system 104 associated with the simulated autonomous vehicle 304. The feedback data can be indicative of, for example, at least one of perception data 212 associated with a simulated object (e.g., 306), prediction data 214 associated with a simulated object (e.g., 306), and/or data indicative of a motion planning data associated with the simulated autonomous vehicle 304 (e.g., data indicative of a motion plan 216, a planned vehicle motion trajectory, vehicle controller instructions, etc.). The simulation system 106 can evaluate the performance of the autonomous vehicle computing system 104, at (620). For example, as described herein, the simulation system 106 can evaluate the autonomous vehicle computing system 104 based at least in part on a comparison of the motion trajectory 312 of the first simulated object 306 (e.g., as determined based on the state data 128) and the predicted motion trajectory of the first simulated object 306 (e.g., as determined by the autonomous vehicle computing system 104).

At (622), the method 600 can include initiating a simulation within another simulated environment. For example, the simulated environment 302 can be a first simulated environment (e.g., utilized during a first simulation run). The motion of a simulated object (e.g., the first simulate object 306) can be a first motion (of that simulated object) within the first simulated environment. The simulation system 106 can obtain data indicative of the motion trajectory 312 of the simulated object 306 within the first simulated environment from the accessible memory 124. The simulation system 106 can present a second simulated environment 402 via a user interface (e.g., 300, 400) on the display device(s) 126. The simulation system 106 can control a second motion of the simulated object (e.g., 306) within the second simulated environment 402 based at least in part on the motion trajectory 312 of the simulated object (e.g., the first simulated object 306) within the first simulated environment 302.

FIG. 6B depicts a flow diagram of another example method 650 for testing autonomous vehicles according to example embodiments of the present disclosure. One or more portion(s) of the method 650 can be implemented by one or more computing devices such as, for example, the one or more computing device(s) of the simulation system 106 and/or other systems. Each respective portion of the method 650 can be performed by any (or any combination) of the one or more computing devices. Moreover, one or more portion(s) of the method 650 can be implemented as an algorithm on the hardware components of the device(s) described herein (e.g., as in FIGS. 1 and 7). FIG. 6B depicts elements performed in a particular order for purposes of illustration and discussion and is not meant to be limiting.

At (652), the method 650 can include obtaining data indicative of a third party simulated environment. The simulation system 106 can obtain data indicative of a third party simulated environment 127 (e.g., from memory 124, a third party memory, etc.). The third party simulated environment 127 can be associated with a testing scenario configured by a third party (e.g., a third party computing system 125). The third party simulated environment 127 can include one or more simulated objects and one or more characteristics, similar to the types of characteristics described herein (e.g., geographic features, weather, etc.). In some implementations, at least one simulated object of the third party simulated environment 127 can be associated with a motion trajectory that is based on user input in a manner similar to that described herein (e.g., provided by a user during a previous simulation run).

At (654), the method 650 can include presenting the third party simulated environment. For instance, the simulation system 106 can present a visual representation of a third party simulated environment 127 via a user interface on a display device. The third party simulated environment 127 can include at least one simulated object and a simulated autonomous vehicle.

At (656), the method 650 can include initiating a simulation within the third party simulated environment. For instance, the simulation system 106 can initiate a simulation run associated with the third party simulated environment 127 (e.g., a first simulation run). As such, the simulation system 106 can start the simulation within the third party simulated environment 127. The simulated object(s) and/or other features of the simulated environment can act (or remain static) according to any initial input(s)/condition(s). The simulation run can occur during a first time period and start at a first time.

The simulation system 106 can control the motion of the simulated object(s) within the third party simulated environment 127. For example, the simulation system 106 can control the motion of a simulated object within the third party simulated environment 127 based at least in part on the motion trajectory associated with the user input for that simulated object. In some implementations, during the simulation run, the simulation system 106 can obtain data indicative of a user input associated with a motion of a simulated object within the third party simulated environment 127. In response to the user input and during the simulation run (e.g., the first simulation run), the simulation system 106 can control the motion of the simulated object within the third party simulated environment 127 based at least in part on the data 110 indicative of the user input. In some implementations, the simulation system 106 can store data indicative of the motion of a simulated object within the third party simulated environment 127 in a manner similar to that described herein with reference to FIGS. 1-6A.

At (658), the method 650 can include controlling a motion of a simulated autonomous vehicle within the third party simulated environment. For instance, the simulation system 106 can provide simulated sensor data associated with the third party simulated environment 127 to the autonomous vehicle computing system 104. The autonomous vehicle computing system 104 can be configured to detect the simulated object(s) in the third party simulated environment 127 based at least in part on such simulated sensor data. The autonomous vehicle computing system 104 can determine a motion plan to navigate the simulated autonomous vehicle through the third party simulated environment 127 based at least in part on the motion of the simulated object(s). The simulation system 106 can obtain (e.g., via the interface 119) an output that includes data associated with a motion of the simulated autonomous vehicle within the third party simulated environment 127 (e.g., based on the motion plan). The simulation system 106 can control the motion of the simulated autonomous vehicle within the third party simulated environment 127 based at least in part on the output obtained via the interface 119 (e.g., from the autonomous vehicle computing system 104). In this way, the simulation system 106 can be configured to implement simulations based on third party submissions, increasing the variety of the testing scenarios that may be utilize to test an autonomous vehicle software stack.

At (660), the method 650 can include obtaining feedback data associated with the simulated autonomous vehicle. For instance, the simulation system 106 can obtain data generated by the autonomous vehicle computing system 104 associated with the third party simulated environment 127. Such data can be indicative of, for example, at least one of perception data 212 associated with a simulated object within the third party simulated environment 127, prediction data 214 associated with a simulated object within the third party simulated environment 127, and/or data indicative of a motion planning data associated with the simulated autonomous vehicle within the third party simulated environment 127 (e.g., data indicative of a motion plan 216, a planned vehicle motion trajectory, vehicle controller instructions, etc.).

At (662), the method 650 can include evaluating a performance of an autonomous vehicle computing system. The simulation system 106 can evaluate the performance of the autonomous vehicle computing system 104 with respect to the third party simulated environment in a manner similar to that described above with respect to FIGS. 1-6A. For example, the simulation system 106 can evaluate the autonomous vehicle computing system 104 based at least in part on a comparison of a motion trajectory of a simulated object within the third party simulated environment 127 (e.g., as determined based on state data) and the predicted motion trajectory of that simulated object (e.g., as determined by the autonomous vehicle computing system 104). The simulation system 104 can re-use and/or playback any of the motion trajectories of the simulated object(s) within the third party simulated environment 127, in a manner similar to that described herein.

FIG. 7 depicts an example system 700 according to example embodiments of the present disclosure. The example system 700 illustrated in FIG. 7 is provided as an example only. The components, systems, connections, and/or other aspects illustrated in FIG. 7 are optional and are provided as examples of what is possible, but not required, to implement the present disclosure. The example system 700 include the simulation system 106 and the autonomous vehicle computing system 104 that can be communicatively coupled to one another over one or more network(s) 810. The user device 102 can also be included in system 700 can be communicatively coupled to the simulation system 106.

The computing device(s) 701 of the simulation system 106 can include processor(s) 702 and a memory 704. The one or more processors 702 can be any suitable processing device (e.g., a processor core, a microprocessor, an ASIC, a FPGA, a controller, a microcontroller, etc.) and can be one processor or a plurality of processors that are operatively connected. The memory 704 can include one or more non-transitory computer-readable storage media, such as RAM, ROM, EEPROM, EPROM, one or more memory devices, flash memory devices, data registrar, etc., and combinations thereof.

The memory 704 can store information that can be accessed by the one or more processors 702. For instance, the memory 704 (e.g., one or more non-transitory computer-readable storage mediums, memory devices) can include computer-readable instructions 706 that can be executed by the one or more processors 702. The instructions 706 can be software written in any suitable programming language or can be implemented in hardware. Additionally, or alternatively, the instructions 706 can be executed in logically and/or virtually separate threads on processor(s) 702.

For example, the memory 704 can store instructions 706 that when executed by the one or more processors 702 cause the one or more processors 702 (the simulation system 106) to perform operations such as any of the operations and functions of the simulation system 106, the operations and functions for testing autonomous vehicles (e.g., one or more portions of methods 600 and 650), any of the operations and functions for which the simulation system 106 is configured, and/or any other operations and functions of the simulation system 106, as described herein.

The memory 704 can store data 708 that can be obtained (e.g., received, accessed, written, manipulated, created, generated, etc.) and/or stored. The data 708 can include, for instance, data associated with simulations, user interfaces, simulated environments, initial inputs/conditions, user inputs, simulated object motion, object states and/or state data, object motion trajectories, simulated autonomous vehicle motion, feedback data, and/or other data/information as described herein. In some implementations, the computing device(s) 701 can obtain data from one or more memories that are remote from the testing system 100.

The computing device(s) 701 can also include a communication interface 709 used to communicate with one or more other system(s) (e.g., the autonomous vehicle computing system 104). The communication interface 709 can include any circuits, components, software, etc. for communicating via one or more networks (e.g., network(s) 710). In some implementations, the communication interface 709 can include, for example, one or more of a communications controller, receiver, transceiver, transmitter, port, conductors, software and/or hardware for communicating data.

The autonomous vehicle computing system 104 can include one or more computing device(s) 721. The computing device(s) 721 can include one or more processors 722 and a memory 724. The one or more processors 722 can be any suitable processing device (e.g., a processor core, a microprocessor, an ASIC, a FPGA, a controller, a microcontroller, etc.) and can be one processor or a plurality of processors that are operatively connected. The memory 724 can include one or more tangible, non-transitory computer-readable storage media, such as RAM, ROM, EEPROM, EPROM, one or more memory devices, flash memory devices, data registrar, etc., and combinations thereof.

The memory 724 can store information that can be accessed by the one or more processors 722. For instance, the memory 724 (e.g., one or more tangible, non-transitory computer-readable storage media, one or more memory devices, etc.) can include computer-readable instructions 726 that can be executed by the one or more processors 722. The instructions 726 can be software written in any suitable programming language or can be implemented in hardware. Additionally, or alternatively, the instructions 726 can be executed in logically and/or virtually separate threads on processor(s) 722.

For example, the memory 724 can store instructions 726 that when executed by the one or more processors 722 cause the one or more processors 722 to perform operations such as any of the operations and functions of the autonomous vehicle computing system 104 or for which the autonomous vehicle computing system 104 is configured, as described herein, and/or any other operations and functions described herein.

The memory 724 can store data 728 that can be obtained and/or stored. The data 728 can include, for instance, input data (e.g., simulated sensor data), perception data, prediction data, motion planning data, feedback data, and/or other data/information as described herein. In some implementations, the computing device(s) 721 can obtain data from one or more memories that are remote from the autonomous vehicle computing system 104.

The computing device(s) 721 can also include a communication interface 729 used to communicate with one or more other system(s) (e.g., the simulation computing system 106, etc.). The communication interface 729 can include any circuits, components, software, etc. for communicating via one or more networks (e.g., network(s) 710). In some implementations, the communication interface 729 can include, for example, one or more of a communications controller, receiver, transceiver, transmitter, port, conductors, software and/or hardware for communicating data.

The network(s) 710 can be any type of network or combination of networks that allows for communication between devices. In some embodiments, the network(s) 710 can include one or more of a local area network, wide area network, the Internet, secure network, cellular network, mesh network, peer-to-peer communication link and/or some combination thereof and can include any number of wired or wireless links. Communication over the network(s) 710 can be accomplished, for instance, via a communication interface using any type of protocol, protection scheme, encoding, format, packaging, etc.

Computing tasks discussed herein as being performed at computing device(s) of one system can instead be performed at another system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system for autonomous vehicle testing, comprising:
one or more processors; and
one or more tangible, non-transitory, computer readable media that collectively store instructions that when executed by the one or more processors cause the computing system to perform operations, the operations comprising:
presenting a visual representation of a simulated environment via a user interface on a display device, wherein the simulated environment comprises a simulated object and a simulated autonomous vehicle;
initiating a simulation run associated with the simulated environment;
during the simulation run, obtaining data indicative of a user input associated with a motion of the simulated object within the simulated environment;
in response to the user input and during the simulation run, controlling the motion of the simulated object within the simulated environment based at least in part on the data indicative of the user input;
obtaining data indicative of a motion trajectory of the simulated object within the simulated environment;
storing the data indicative of the motion trajectory of the simulated object within the simulated environment in an accessible memory;
obtaining, via an interface, an output from an autonomous vehicle computing system, wherein the output comprises data associated with a motion of the simulated autonomous vehicle, wherein the motion of the simulated autonomous vehicle is based at least in part on the motion of the simulated object; and
controlling the motion of the simulated autonomous vehicle within the simulated environment based at least in part on the output from the autonomous vehicle computing system that is obtained via the interface.

2. The computing system of claim 1, wherein the output is indicative of one or more command signals from the autonomous vehicle computing system, and wherein the one or more command signals are indicative of the motion of the simulated autonomous vehicle.

3. The computing system of claim 1, wherein the one or more processors are one or more first processors, and wherein the interface is configured to communicate with one or more second processors that are different than the one or more first processors, and wherein the one or more second processors are configured to implement the autonomous vehicle computing system.

4. The computing system of claim 1, wherein the simulated environment is a first simulated environment, wherein the motion of the simulated object is a first motion of the simulated object within the first simulated environment, and wherein the operations further comprise:
presenting a second simulated environment;
obtaining the data indicative of the motion trajectory of the simulated object within the first simulated environment; and
controlling a second motion of the simulated object within the second simulated environment based at least in part on the motion trajectory of the simulated object within the first simulated environment.

5. The computing system of claim 1, wherein obtaining the data indicative of the motion trajectory of the simulated object within the simulated environment comprises:
obtaining state data indicative of one or more states of the simulated object within the simulated environment; and
determining the motion trajectory of the simulated object based at least in part on the one or more states of the simulated object within the simulated environment.

6. The computing system of claim 5, wherein the operations further comprise:
parameterizing the one or more states into parameter data associated with the simulated environment, wherein the parameter data is indicative of a relationship between the simulated object and the simulated environment.

7. The computing system of claim 1, wherein controlling the motion of the simulated object within the simulated environment based at least in part on the data indicative of the user input comprises:
controlling the motion of the simulated object within the simulated environment in at least near real-time based at least in part on the data indicative of the user input.

8. The computing system of claim 1, wherein the operations further comprise:
providing simulated sensor data to the autonomous vehicle computing system, wherein the autonomous vehicle computing system is configured to detect the simulated object based at least in part on the simulated sensor data.

9. A computer-implemented method for testing autonomous vehicles, comprising:
presenting, by a computing system that comprises one or more computing devices, a visual representation of a simulated environment via a user interface on a display device, wherein the simulated environment comprises a simulated object and a simulated autonomous vehicle;
initiating, by the computing system, a simulation run associated with the simulated environment;
during the simulation run, obtaining, by the computing system, data indicative of a user input associated with a motion of the simulated object within the simulated environment;
in response to the user input and during the simulation run, controlling, by the computing system, the motion of the simulated object within the simulated environment based at least in part on the data indicative of the user input;
obtaining, by the computing system via an interface, an output from an autonomous vehicle computing system, wherein the output is indicative of one or more command signals associated with a motion of the simulated autonomous vehicle, wherein the motion of the simulated autonomous vehicle is based at least in part on the motion of the simulated object; and
controlling, by the computing system, the motion of the simulated autonomous vehicle within the simulated environment based at least in part on the output from the autonomous vehicle computing system that is obtained via the interface.

10. The computer-implemented method of claim 9, wherein the one or more command signals are associated with a motion plan generated by the autonomous vehicle computing system for the simulated autonomous vehicle, wherein the motion plan is based at least in part on the motion of the simulated object.

11. The computer-implemented method of claim 9, further comprising:
obtaining, by the computing system, state data indicative of one or more states of the simulated object within the simulated environment;
determining, by the computing system, a motion trajectory of the simulated object based at least in part on the one or more states; and
storing in an accessible memory, by the computing system, at least one of the state data indicative of the one or more states of the simulated object or data indicative of the motion trajectory of the simulated object.

12. The computer-implemented method of claim 11, wherein the simulated environment is a first simulated environment, wherein the motion of the simulated object is a first motion within the first simulated environment, and wherein the method further comprises:
obtaining, by the computing system, the data indicative of the motion trajectory of the simulated object within the first simulated environment from the accessible memory;
presenting, by the computing system, a second simulated environment via the user interface on the display device; and
controlling, by the computing system, a second motion of the simulated object within the second simulated environment based at least in part on the motion trajectory of the simulated object.

13. The computer-implemented method of claim 11, further comprising:
parameterizing the one or more states into parameter data associated with the simulated environment, wherein the parameter data is indicative of a relationship between the simulated object and the simulated environment.

14. The computer-implemented method of claim 13, wherein at least one of the one or more parameters is utilized to initiate at least a portion of a second motion of the simulated object within a second simulated environment.

15. The computer-implemented method of claim 9, further comprising:
obtaining, by the computing system, feedback data associated with an autonomous vehicle computing system associated with the simulated autonomous vehicle, wherein the feedback data is indicative of at least one of simulated perception data associated with the simulated object, simulated prediction data associated with the simulated object, or simulated motion planning data associated with the simulated autonomous vehicle.

16. The computer-implemented method of claim 15, wherein the simulated prediction data is indicative of a predicted motion trajectory of the simulated object, and wherein the method further comprises:
evaluating the autonomous vehicle computing system based at least in part on a comparison of the motion trajectory of the simulated object and the predicted motion trajectory of the simulated object.

17. The computer-implemented method of claim 9, wherein the simulated object is a first simulated object, wherein the simulated environment comprises a second simulated object, and wherein the method further comprises:
obtaining, by the computing system, data indicative of a second user input associated with a motion of the second simulated object within the simulated environment; and
controlling, by the computing system, the motion of the second simulated object within the simulated environment based at least in part on the data indicative of the second user input.

18. The computer-implemented method of claim 17, wherein the simulation run is a first simulation run associated with the simulated environment, wherein the first simulation run occurs at a first time period, wherein state data indicative of one or more states of the first simulated object is obtained during the first time period, the method further comprising:
obtaining, by the computing system, state data indicative of one or more states of the second simulated object within the simulated environment during a second simulation run associated with the simulated environment, wherein the second simulation run occurs at a second time period that is subsequent to the first time period;
determining, by the computing system, a motion trajectory of the second simulated object based at least in part on the one or more states of the second simulated object within the simulated environment; and
storing in an accessible memory, by the computing system, at least one of the state data indicative of the one or more states of the second simulated object or data indicative of the motion trajectory of the second simulated object.

19. An autonomous vehicle testing system, comprising:
a user input device configured to provide data indicative of a user input associated with a motion of a simulated object;
an autonomous vehicle computing system configured to control a simulated autonomous vehicle; and
a simulation computing system comprising one or more processors and one or more tangible, non-transitory, computer readable media that collectively store instructions that when executed by the one or more processors cause the simulation computing system to perform operations, the operations comprising:
presenting a visual representation of a simulated environment via a user interface on a display device, wherein the simulated environment comprises the simulated object and the simulated autonomous vehicle;
initiating a simulation run associated with the simulated environment;
during the simulation run, obtaining, via the user input device, the data indicative of the user input associated with the motion of the simulated object within the simulated environment;
in response to the user input and during the simulation run, controlling the motion of the simulated object within the simulated environment based at least in part on the data indicative of the user input;
obtaining, via an interface, an output from the autonomous vehicle computing system, wherein the output is associated with a motion of the simulated autonomous vehicle; and
controlling the motion of the simulated autonomous vehicle within the simulated environment based at least in part on the output from the autonomous vehicle computing system.

20. The autonomous vehicle testing system of claim 19, wherein the user input device has a form factor associated with a type of the simulated object.
